(19) United States
(12) Patent Application Publication
(10) Pub. No.: US 2025/0081271 A1
(43) Pub. Date: Mar. 6, 2025

(54) FAST DIRECT SCELL ACTIVATION

(71) Applicant: Apple Inc., Cupertino, CA (US)

(72) Inventors: Qiming LI, Beijing (CN); Dawei ZHANG, Saratoga, CA (US); Hong HE, San Jose, CA (US); Huaning NIU, San Jose, CA (US); Jie CUI, San Jose, CA (US); Manasa RAGHAVAN, Sunnyvale, CA (US); Xiang CHEN, Campbell, CA (US); Yang TANG, San Jose, CA (US); Yushu ZHANG, Beijing (CN)

(21) Appl. No.: 18/726,249

(22) PCT Filed: Jan. 6, 2022
(86) PCT No.: PCT/CN2022/070560

§ 371 Date: Jul. 2, 2024

(51) Int. Cl. H04W 76/20; H04L 5/00; H04W 52/52; H04W 80/02

(52) U.S. Cl. CPC H04W 76/20; H04L 5/0051; H04W 52/52; H04W 80/02

(57) ABSTRACT

Systems, apparatus, methods, and computer programs for fast, direct SCell activation are disclosed. In one aspect, a method can include receiving, by a UE, an RRC command that causes the UE to be configured to detect a TRS transmission of a plurality of TRS transmission bursts broadcast by an access node, disregarding, by the UE, one or more TRS transmission of the plurality of TRS transmission bursts that are received, by the UE, during processing of the received RRC command, and after processing, by the UE, of the received RRC command, decoding a TRS transmission of the plurality of TRS bursts that is received subsequent to completion of processing of the received RRC command for automatic gain control (AGC).

### BACKGROUND

The present disclosure is generally related to direct secondary cell (SCell) activation in a wireless communication network.

### SUMMARY

In conventional methods such as R15 NR, typical SCell activation was achieved using a MAC-CE as shown in the process flow 100 of FIG. 1. The MAC-CE can be used to configure a UE to monitor for SSB transmissions for AGC and T/F tracking. While functional, this implementation is undesirable due to the activation latency that is incurred via use of MAC-CE and SSB transmissions.

Other conventional methods such as R16 NR have proposed eliminating the MAC-CE for direct activation of an SCell, but still use periodic SSB transmissions for direct activation of an SCell as shown in the process flow 200 of FIG. 2. This is achieved by modifying the RRC signaling layer to configure a UE to monitor for SSB transmissions for direct activation of an SCell. Such methods reduce the latency of the direct SCell activation process of R15 NR, but are still burdened by the latency inherent in the periodic transmission of the SSB transmissions.

Yet other conventional methods such as R17 NR have proposed using a MAC-CE for direct activation of an SCell by using the MAC-CE element to configure a UE to monitor for periodic TRS transmissions as shown in the process flow 300 of FIG. 3. Such methods, however, still incur high latency due to use of the MAC-CE and the periodicity of the TRS transmission initiated using the MAC-CE. In these conventional methods, the MAC-CE causes the TRS transmissions to be transmitted immediately after the MAC-CE. Nonetheless, the periodicity of the TRS transmission in such implementations can be associated with a periodic latency of up to 160 ms.

However, even with the improvements proposed in R16 and R17, significant latencies are incurred in both methods. With respect to R16, the periodicity of these SB transmission can result in latencies up to 160 ms. Regarding R17, the delay of the MAC-CE transmission and the periodic TRS transmission results in greater latencies as the delays of the MAC-CE transmission are added on top of the latency associated with the periodic transmission of the TRS transmission, which, can be associated with a periodic latency of up to 160 ms.

None of the prior proposals have signaling layer that facilitates direct SCell activation using the RRCE signaling layer without both periodic SB or TRS transmissions.

According to one innovative aspect of the present disclosure a method for direct SCell activation is disclosed. In one aspect, the method can further include generating, by an access node, an RRC command that includes one or more parameters that, when processed by a UE, cause the UE to be configured to detect a TRS transmission of a plurality of TRS transmission bursts broadcast by the access node, encoding, by the access node, the generated RRC command for transmission to the UE, transmitting, by the access node, the encoded RRC command to the UE, and after transmitting the encoded RRC command to the UE, transmitting, by the access node, a plurality of TRS transmission bursts to the UE.

Other aspects includes apparatuses, systems, and computer programs for performing the actions of the aforementioned operations.

The innovative method can include other optional features. For example, in some implementations, after transmitting the encoded RRC command to the UE, transmitting, by the access node, a plurality of TRS transmission bursts to the UE can include based on a determination that a predetermined amount of time has expired after transmitting the encoded RRC command to the UE, transmitting, by the access node, a plurality of TRS transmission bursts to the UE.

In some implementations, after transmitting the encoded RRC command to the UE, transmitting, by the access node, a plurality of TRS transmission bursts to the UE can include based on a determination that the RRC process has been completed by the UE, transmitting, by the access node, a plurality of TRS transmission bursts to the UE.

In some implementations, each TRS transmission burst can include a plurality of TRS transmissions.

In some implementations, the generated RRC command can include data that indicates that there will be a plurality of TRS transmission bursts broadcast by the access node after RRC configuration.

In some implementations, the generated RRC command can include data that indicates a TRS configuration.

In some implementations, the method can further include receiving, by the access node, a CSI report notification from the UE after CSI measurement has been completed by the UE.

In some implementations, the generated RRC command can further include a data corresponding to an offset value, wherein the offset value is specified in units of slot relative to the slot in which the RRC command was received.

In some implementations, the generated RRC command can further include data that causes the UE to enable SP-TRS activation.

In some implementations, the method can further include generating, by the access node and after receipt of a CSI report notification from the UE, a MAC-CE that includes data that configures the UE to deactivate SP-TRS, encoding, by the access node, the generated MAC-CE for transmission to the UE, and transmitting, by the access node, the encoded MAC-CE to the UE.

According to one innovative aspect of the present disclosure, another method for direct SCell activation is disclosed. In one aspect, the method can include receiving, by a UE, an RRC command that causes the UE to be configured to detect a TRS transmission of a plurality of TRS transmission bursts broadcast by an access node, disregarding, by the UE, one or more TRS transmission of the plurality of TRS transmission bursts that are received, by the UE, during processing of the received RRC command, and after processing, by the UE, of the received RRC command, decoding, by the UE, a TRS transmission of the plurality of TRS transmission bursts that was received subsequent to completion of processing of the received RRC command for automatic gain control (AGC).

Other aspects includes apparatuses, systems, and computer programs for performing the actions of the aforementioned operations.

The innovative method can include other optional features. For example, in some implementations, each TRS transmission burst can include a plurality of TRS transmissions.

In some implementations, decoding, by the UE, a TRS transmission of the plurality of TRS transmission bursts that is received subsequent to completion of processing of the received RRC command for AGC can include decoding, by the UE, a first TRS transmission of the plurality of TRS transmission bursts that is received subsequent to completion of processing of the received RRC command for AGC.

In some implementations, the method can further include decoding another TRS transmission of the plurality of TRS transmission bursts that is received subsequent to completion of processing of the received RRC command and completion of AGC for T/F tracking.

In some implementations, the received RRC command can include data corresponding to an offset value, wherein the offset value is specified in units of slot relative to the slot in which the RRC command was received.

In some implementations, the received RRC command can include data that causes the UE to enable SP-TRS activation.

In some implementations, the method can further include receiving, by the UE and subsequent to decoding of (1) a TRS transmission for AGC and (2) a TRS transmission for T/F tracking, a MAC-CE that includes data that configures the UE to deactivate SP-TRS.

According to one innovative aspect of the present disclosure, another method for direct SCell activation is disclosed. In one aspect, the method can include generating, by an access node, an RRC command that causes the UE to be configured to initiate UE triggered aperiodic TRS (A-TRS), encoding, by the access node, the generated RRC command for transmission to the UE, transmitting, by the access node, the encoded RRC command to the UE, obtaining, by the access node, data corresponding to a notification, from the UE, that includes data indicating that the UE is ready for A-TRS, and transmitting, by the access node, TRS transmissions to the UE in response to the obtained notification from the UE.

Other aspects includes apparatuses, systems, and computer programs for performing the actions of the aforementioned operations.

The innovative method can include other optional features. For example, in some implementations, the RRC command can include data indicating a candidate A-TRS configuration. In such implementations, transmitting, by the access node, TRS transmissions to the UE in response to the obtained notification from the UE can include transmitting, by the access node, TRS transmissions to the UE in response to the obtained notification form the UE based on the candidate A-TRS configuration indicated by the RRC command.

In some implementations, the method can further include obtaining, by the access node, a notification, from the UE, includes data indicating a request for DCI to trigger A-TRS transmissions, and in response to the obtained request for DCI to trigger A-TRS transmissions, transmitting, by the access node, a DCI command to the UE to trigger A-TRS.

In some implementations, the DCI command can be transmitted via the SCell being activated.

In some implementations, the DCI command can be transmitted via another active cell other than the SCcell being activated.

In some implementations, method can further include obtaining, by the access node, a CSI report from the UE.

According to one innovative aspect of the present disclosure, another method for direct SCell activation is disclosed. In one aspect, the method can include receiving, by a UE and from an access node, an RRC command that causes the UE to be configured to initiate UE triggered aperiodic TRS (A-TRS), after RRC processing, transmitting, by the UE, a notification to the access node that includes data indicating that the UE is ready for A-TRS, monitoring, by the UE, for A-TRS transmissions from the access node, and based on a determination, by the UE, that an A-TRS transmission has been received, decoding the received A-TRS transmission for automatic gain control (AGC).

Other aspects includes apparatuses, systems, and computer programs for performing the actions of the aforementioned operations.

The innovative method can include other optional features. For example, in some implementations, method can further include based on a determination, by the UE, that an A-TRS transmission has not been received, transmitting another notification to the access node that includes data indicating a request for DCI to trigger A-TRS transmissions.

In some implementations, the RRC command can include a candidate A-TRS configuration.

In some implementations, the candidate TRS configuration can define a schedule of A-TRS transmissions to be transmitted to the UE by the access node.

In some implementations, the method can further include decoding, by the UE, another A-TRS transmission that is received subsequent to completion of processing of completion of AGC for T/F tracking.

In some implementations, the method can further include decoding, by the UE, another A-TRS transmission that is received subsequent to completion of processing of completion of AGC and completion of T/F tracking for CSI measurement.

In some implementations, method can further include transmitting, by the UE, a CSI report to the access node.

These and other innovative aspects of the present disclosure are described in more detail herein in the detailed description, the accompanying drawings, and the claims.

### BRIEF SUMMARY OF THE DRAWINGS

FIG. 1 is a flow diagram of a conventional process flow for using a MAC-CE and periodic SSB transmissions for SCell activation.

FIG. 2 is a flow diagram of a conventional process flow for using SSB transmission without a MAC-CE for SCell activation.

FIG. 3 is a flow diagram of a conventional process flow for using MAC-CE and periodic TRS transmissions for SCell activation.

FIG. 4 is a flow diagram of a process flow for fast, direct SCell activation in accordance with one aspect of the present disclosure.

FIG. 5 is another flow diagram of process flow for fast, direct SCell activation in accordance with another aspect of the present disclosure.

FIG. 6 is a flowchart of a process for fast, direct SCell activation operations performed by an access node in accordance one aspect of the present disclosure.

FIG. 7 is a flowchart of a process for fast, direct SCell activation operations performed by a UE in accordance with one aspect of the present disclosure.

FIG. 8 is a flow diagram of a process flow for UE triggered A-TRS in accordance with another aspect of the present disclosure.

FIG. 9 is a flowchart of a process for fast, direct SCell activation operations performed by an access node using UE triggered A-TRS in accordance with another aspect of the present disclosure.

FIG. 10 is a flowchart of a process for fast, direct SCell activation operations performed by a UE using UE triggered A-TRS in accordance with another aspect of the present disclosure.

FIG. 11 is a block diagram of an example device architecture, according to some implementations of the present disclosure.

FIG. 12 illustrates an example of a wireless communication system, according to some implementations of the present disclosure.

FIG. 13 illustrates an example of infrastructure equipment, according to some implementations of the present disclosure.

FIG. 14 illustrates example components of baseband circuitry and radio front end modules (RFEM), according to some implementations of the present disclosure.

FIG. 15 is a block diagram illustrating components able to read instructions from a machine-readable or computer-readable medium (e.g., a non-transitory machine-readable storage medium) and perform any one or more of the methodologies discussed herein, according to some implementations of the present disclosure.

Like reference symbols in the various drawings indicate like elements.

### DETAILED DESCRIPTION

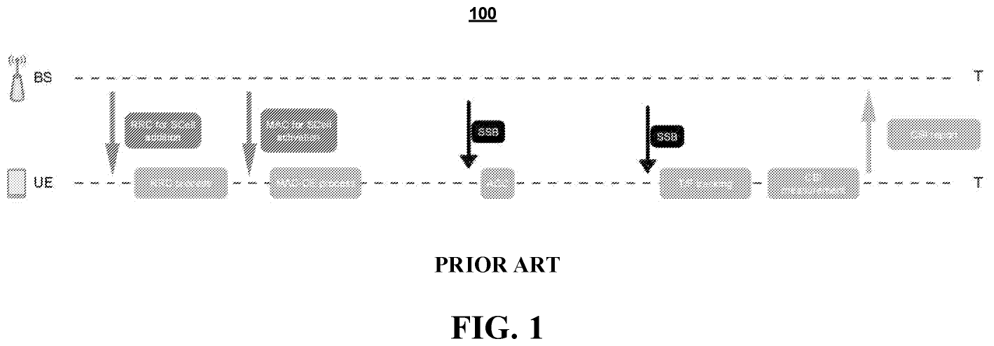

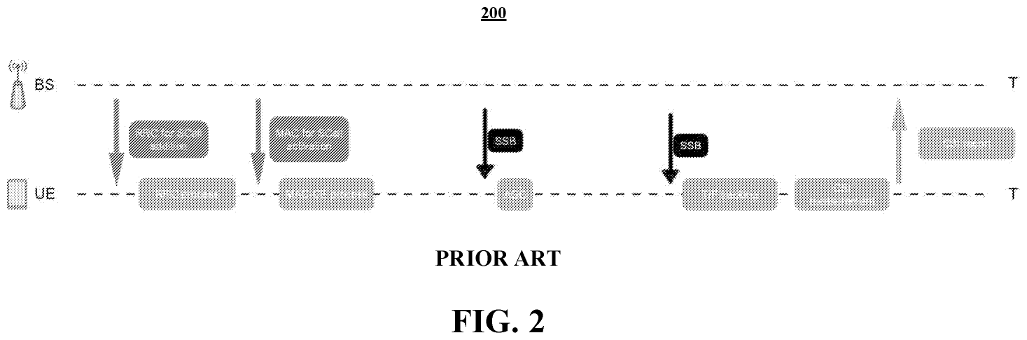

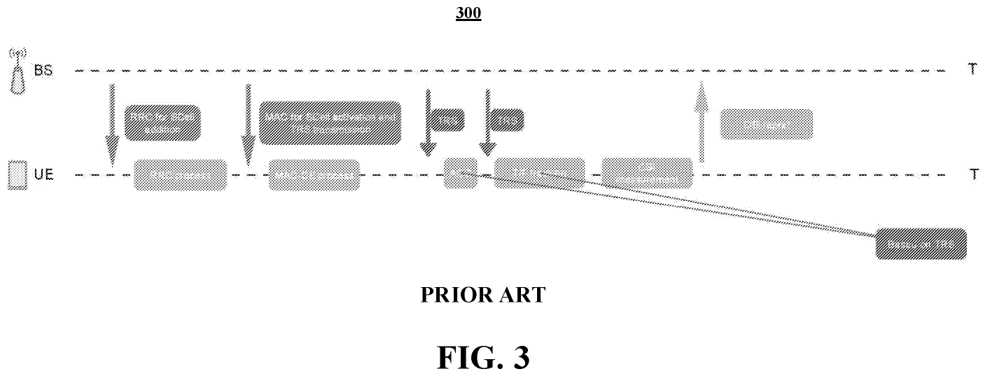

The present disclosure is directed towards systems, apparatus, methods, and computer programs for fast direct secondary cell (SCell) activation relative to conventional direct SCell activations. The direct SCell activation procedure can include automatic gain control (AGC) and T/F tracking operations referenced herein. Conventional systems such as those shown in FIGS. 1-3 utilize periodic transmissions and/or a MAC control element (MAC-CE) that each incur significant latencies in order to perform direct SCell activation. The present disclosure avoids these latencies by modifying the RRC signaling layer to configure a UE to monitor for tracking reference signal (TRS) transmission bursts that can be used to directly activate an SCell. Accordingly, the use of a MAC-CE to configure TRS transmissions, and the associated latencies of the MAC-CE, can be avoided using the present disclosure.

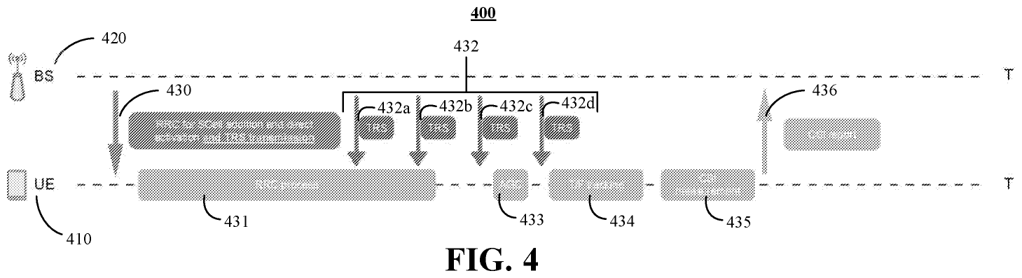

FIG. 4 is a flow diagram of a process flow 400 for fast, direct SCell activation in accordance with one aspect of the present disclosure. The process flow 400 shows transmissions between a user equipment 410 and an access node or base station 420. The user equipment 410 can include any user device such as a smartphone, a tablet computer, a smartwatch, or any other device configured to communicate with a mobile network provided by the access node 420. The access node or base station 420 can include, for example, a gNodeb of a 5G NR mobile network.

In some implementations, the access node 420 can generate an RRC command 430 that can configure the UE 420 to detect one or more TRS transmission 432a, 432b, 432c, 432d of one or more TRS transmission bursts 432. In some implementations, the access node 420 may transmit a single TRS transmission burst 432. In other implementations, the access node 420 may transmit a several TRS transmission bursts 432. Several TRS transmission bursts 432 can include two or more TRS transmission bursts 432. For example, several TRS transmission bursts can include 2 TRS transmission bursts 432, 3 TRS transmission bursts, 4 TRS transmission bursts, 10 TRS transmission bursts, or more.

In conventional systems, P-TRS have been be triggered via RRC command to achieve, e.g., T/F tracking for active cell. However, the periodicity of P-TRS is comparable to the periodicity of SSB (e.g., up to 160 ms). Accordingly, the present disclosure has modified the RRC signaling layer to accommodate non-periodic TRS transmission. Non-periodic TRS transmission is achieved, as described above and shown in FIG. 4 by using an RRC command 430 to configure the UE 410 to monitor for and detect one or more TRS transmissions 432a, 432b, 432c, 432d in one or more TRS transmission bursts 432 broadcast by the access node 420 to make use of TRS transmissions for direct SCell activation while avoiding the latencies associated with P-TRS transmissions of conventional methods.

In some implementations, the RRC command can include non-zero power channel state information reference signal (NZP-CSI-RS) resource sets, which can be configured as a temporary reference signal (RS) for a given cell. In some implementations, for example, one of the NZP-CSI-RS resources sets can be selected explicitly by the same RRC signaling command to trigger A-TRS transmission for AGC settling and T/F tracking. Alternatively, in other implementations, one flag information element (IE) can be included in the same RRC signaling. In such implementations, if the flag is enabled, the NZP-CSI-RS resources set with a lowest ID is triggered for RRC-direct SCell activation.

In the process flow 400, the access node 420 can generate, encode, and transmit RRC command 430 to the UE 410 for direct SCell activation. The access node 420 uses the RRC command 430 inform UE 410 that there will be one or more TRS transmission bursts 432 that are to be used for TRS configuration after RRC configuration is complete. Receipt and processing of the RRC command 430 by the UE 410 configures the UE 410 to monitor for and detect TRS transmissions 432a, 432b, 432c, 432d in one or more TRS transmissions bursts after RRC configuration is complete.

After RRC processing 431 is completed by the UE 410, the UE 410 receives and decodes an TRS transmission detected by the UE 410 at a point in time after RRC processing 431 is completed. In some implementations, this can be the first TRS transmission received, or otherwise detected, by the UE 410 after RRC processing 431 is completed. In other implementations, it may be any TRS transmission received, or otherwise detected, by the UE 410 after completion of RRC processing 431. The received and decoded TRS transmissions detected by the UE 410 after completion of RRC processing 431 can be used for AGC 433 and T/F tracking 434. In some implementations, the same TRS transmission 432c can be used for both AGC 433 and T/F tracking 434. In other implementations, different TRS transmissions 432c and 432d can be used for the AGC 433 and T/F tracking 434, respectively. In some implementations, corresponding latency requirements can be those specified by TS38.133.

In some implementations, the RRC command 430 can also explicitly provide an offset value that indicates a slot to be used for the TRS transmission bursts 432. For example, in some implementations, can be based on units of slot relative to the slot of RRC command reception. In such implementations, a UE 410 can then determine based on the offset value in the RRC command 430, when to start monitoring for incoming TRS transmission for direct SCell activation. The offset should be larger than or equal to a threshold value, which is either hard-encoded in specification or reported as part of UE capability report.

Upon completion of AGC 433 and T/F tracking 434, the UE can perform CSI measurement 435. Upon completion of CSI measurement, the UE can transmit a notification with a CSI report 436 to the access node 430.

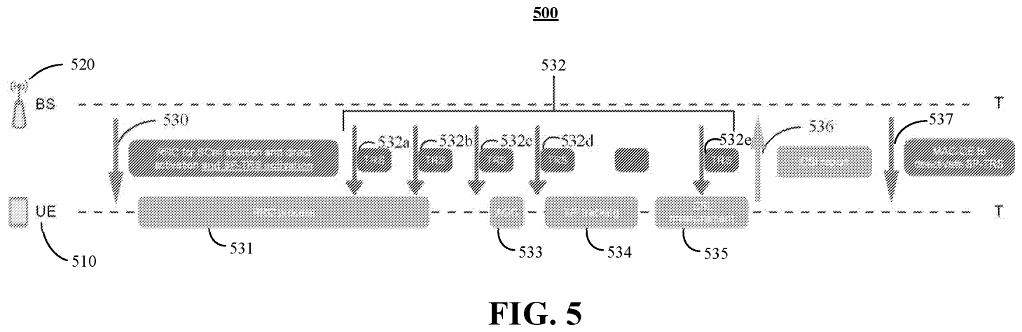

FIG. 5 is another flow diagram of process flow 500 for fast, direct CELL activation in accordance with another aspect of the present disclosure. The process flow 500 is similar to the process flow 400 in that the process flow 500 enables the elimination of the MAC-CE element for direct SCell activation and its corresponding latency. In the process flow 500, however, the RRC signaling command has been modified to trigger semi-persistent TRS (SP-TRS) transmission.

In conventional methods, semi-persistent TRS has only be activated or deactivated using MAC-CE. However, in the process flow 500 of the present SP-TRS activation MAC-CE is eliminated, along with its corresponding latency, by modifying the RRC signaling layer. Accordingly, SP-TRS activation can occur in the process flow 500 using the same RRC command 530 as is used for direct SCell activation. The remainder of the process flow 500 is the same as process flow 400, with elements 531, 532, 533, 534, 535, and 536 corresponding to 431. 432, 433, 434, 435, and 436, respectively. Operations of the access node 520 and UE 510 are likewise the same to this point in the process flow. However, the process flow 500 deviates from process flow 400 in that a MAC-CE 537 is generated by the access node 520, encoded, and then transmitted to the UE 510 in order to deactivate the SP-TRS. The generation, encoding, and transmission of the deactivation MAC-CE 537 can be triggered upon receipt, by the access node, of the CSI report 536 provided by the UE. Between activation and deactivation the SP-TRS can be repeatedly broadcast by the access node 520 with a frequency that is greater, thereby having less latency, than conventional periodic implementations of SBS and TRS described with respect to FIGS. 1-3.

The received and decoded TRS transmissions detected by the UE 410 after completion of RRC processing 431 can be used for AGC 433 and T/F tracking 434. In some implementations, the same TRS transmission 432c can be used for both AGC 433 and T/F tracking 434. In other implementations, different TRS transmissions 432c and 432d can be used for the AGC 433 and T/F tracking 434, respectively. In some implementations, corresponding latency requirements can be those specified by TS38.133.

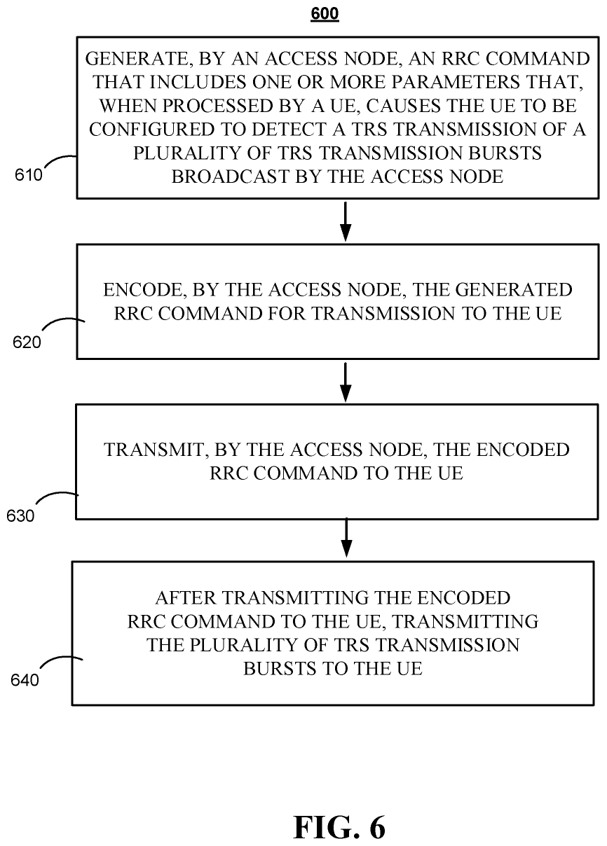

FIG. 6 is a flowchart of a process 600 for fast, direct SCELL activation operations performed by an access node in accordance one aspect of the present disclosure. For convenience, the process 600 will be described below as being performed by an access node such as an access node 420 or 520.

A access node can be execution of the process 600 by generating 610 an RRC command that includes one or more parameters that, when processed by a UE, cause the UE to be configured to detect a TRS transmission of a plurality of TRS transmission bursts broadcast by the access node. For example, in some implementation, the generated RRC command can include data that indicates that there will be a plurality of TRS transmission bursts broadcast by the access node after RRC configuration. In some implementations, the generated RRC command can include data that indicates a TRS configuration. In these, or other implementations, the generated RRC command can include data that indicates that there will be a plurality of TRS transmission bursts broadcast by the access node after RRC configuration.

In some implementations, the generated RRC command further includes a data corresponding to an offset value, wherein the offset value is specified in units of slot relative to the slot in which the RRC command was received. In these, or other implementations, the generated RRC command further includes data that causes the UE to enable SP-TRS activation.

The access node can continue execution of the process 600 by encoding 620 the generated RRC command for transmission to the UE and then transmitting 630 the encoded RRC command to the UE.

Then, after transmitting the encoded RRC command to the UE, the access node can continue execution of the process 600 by transmitting 640 a plurality of TRS transmission bursts to the UE. In some implementations, stage 640 can include the access node determining that a predetermined amount of time has expired after transmitting the encoded RRC command to the UE, and then transmitting a plurality of TRS transmission bursts to the UE. Alternatively, or in addition, stage 640 can include the access node determining that the RRC process has been completed by the UE, and then transmitting a plurality of TRS transmission bursts to the UE.

In some implementations, the process 600 can continue with the access node receiving. from the UE, a CSI report. Then, responsive to receipt of the CSI report, the access node can generate a MAC-CE that includes data that configures the UE to deactivate SP-TRS. The access node can then encode and transmit the generated MAC-CE to the UE.

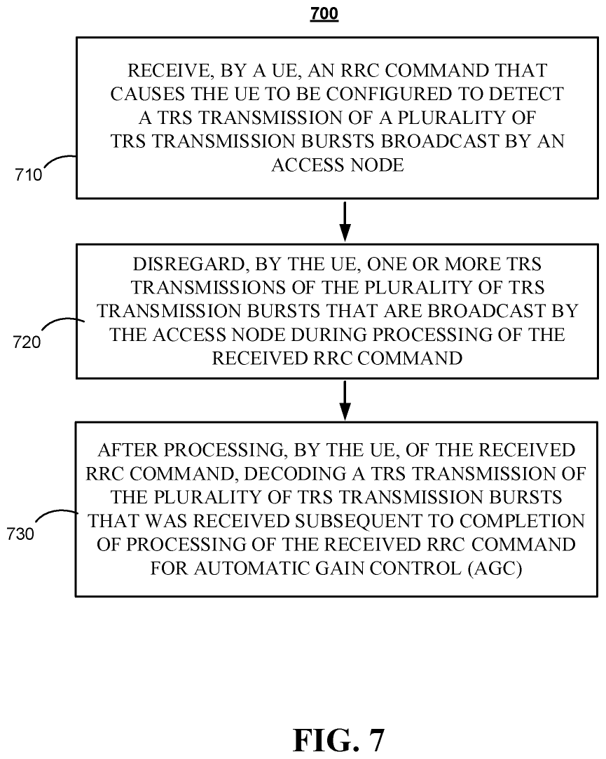

FIG. 7 is a flowchart of a process 700 for fast, direct SCELL activation operations performed by a UE in accordance with one aspect of the present disclosure. For convenience, the process 700 will be described below as being performed by a UE such as an UE 410 or 510.

A UE can begin execution of the process 700 by receiving 710 an RRC command that causes the UE to be configured to detect a TRS transmission of a plurality of TRS transmission bursts broadcast by an access node. In some implementations, the received RRC command can also include data corresponding to an offset value. For example, the offset value can be specified in units of slot relative to the slot in which the RRC command was received.

The UE can continue execution of the process 700 by disregarding 720 one or more TRS transmissions of the plurality of TRS transmission bursts that are transmitted by the access node during processing of the received RRC command. In some implementations, disregarding can include the UE receiving a TRS transmission during RRC command processing and the UE ignoring, or otherwise not acting upon, the TRS transmission. In other implementations, disregarding one or more TRS transmission burst may include the UE ignoring, or otherwise not acting upon, the TRS transmission regardless of whether the UE fully received and/or processed the TRS transmission. In some implementations, for example, the UE may disregard a TRS transmission that the UE was expecting to be transmitted by the access node.

After processing, by the UE, of the received RRC command, the UE can continue execution of the process 700 by decoding a TRS transmission of the plurality of TRS transmission bursts that was received subsequent to completion of processing of the received RRC command for automatic gain control (AGC). In some implementations, decoding can include decoding a first TRS transmission of the plurality of TRS transmission bursts that is received subsequent to completion of processing of the received RRC command for AGC. Alternatively, or in addition, decoding can also include decoding another TRS transmission of the plurality of TRS transmission bursts that is received subsequent to completion of processing of the received RRC command and completion of AGC for T/F tracking.

In some implementations, the received RRC command can also include data that causes the UE to enable SP-TRS activation. In such implementations, after the UE completes RRC processing, AGC. T/F, and CSI measurement, the UE can transmit a CSI report to the access node that indicates that CSI measurement has been completed. In such implementations, the UE can continue the process 700 by receiving a MAC-CE that includes data that configures the UE to deactivate SP-TRS.

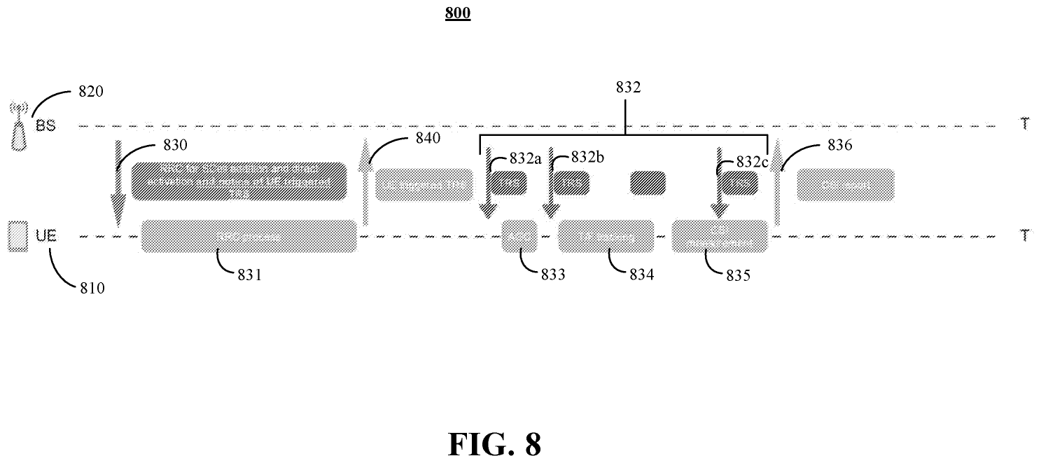

FIG. 8 is a flow diagram of a process flow 800 for UE triggered A-TRS in accordance with another aspect of the present disclosure. The process flow 800 has many similarities to the process flows 400 and 500. For example, the RRC processing 831, AGC 833, T/F tracking 834, CSI measurement 836, and TRS transmission are similar to those described in process flows 400 and 500. However, the process flow 800 differs from the process flows 400 and 500 in that the access node does not trigger transmission of the TRS transmissions. Instead, in process flow 800, the UE 810 triggers TRS transmissions.

The TRS transmissions used in process flow 800 are aperiodic TRS (A-TRS) transmissions. In conventional systems, A-TRS transmissions are triggered using DCI. However, these conventional systems have two problems—(1) according to current spec, it is unclear whether UE needs to receive DCI for A-TRS for the SCell being activated and (2) it is unclear to access node 820 exactly when to trigger such A-TRS.

The process flow 800 solves these problems modifying the RRC signaling command 830 to configure the UE to trigger A-TRS. For example, the same RRC command 830 that is used for direct SCell activation can be modified to also include data that indicates, to the UE 810, that the UE shall inform the access node 820 when the UE is ready for A-TRS. In some implementations, the RRC command 830 can also include a candidate TRS configuration.

In a first implementations, after RRC processing. UE 810 shall transmit a notification 840 to the access node 820 that indicates that the UE 810 is ready for A-TRS. The notification 840 can be transmitted by PUCCH. For example, the PUCCH may be a scheduling request dedicatedly configured for A-TRS triggering. In some implementations, the notification 840 can be transmitted by PUSCH. For example, an uplink MAC layer message can be used for notification 840. In some implementations, both PUCCH and PUSCH can be used for the notification 840.

Then, the access node 820, after receiving the notification 840 from the UE 810, can transmit A-TRS transmissions 842a, 842b, 842c according to the candidate TRS configuration of the RRC command 830. Meanwhile, after informing access node 820 that the UE 810 is read for A-TRS, the UE 810 can begin monitoring for TRS transmissions in accordance with the candidate A-TRS configuration in the RRC command 830. However, the present disclosure is not limited to such implementations.

In another implementation, after receiving notification 840 from the UE, the access node 820 can send a DCI command to trigger A-TRS. The notification 840 can be transmitted by PUCCH. For example, the PUCCH may be a scheduling request dedicatedly configured for A-TRS triggering. In some implementations, the notification 840 can be transmitted by PUSCH. For example, an uplink MAC layer message can be used for notification 840. In some implementations, both PUCCH and PUSCH can be used for the notification 840. The DCI command can transmitted via the SCell being activated using process flow 800 or via other active cells. Then, the UE 810, after transmitting the notification 840 to trigger A-TRS, waits and monitors for the DCI to trigger A-TRS.

In some implementations, the UE 820 can be configured with one scheduling request (SR) per component carrier (CC) or one SR across CCs. In some implementations, the MAC-CE may indicate the CC index(es) to indicate the CCs ready for A-TRS. In some implementations, the access node 820 may configure a monitoring window and maximum number of retransmission for the notification 840.

In some implementations, UE 810 can start to monitor for a triggered A-TRS or DCI command on the SCell after a predetermined number of “X” symbols after it sends the request, where “X” is any positive integer greater than 0. If UE 810 cannot detect any triggered A-TRS or DCI command on the SCell, UE 810 can retransmit the notification 840. If the number of retransmission attempts for the notification 840 satisfies a predetermined threshold and the UE 810 still cannot detect any A-TRS or DCI command, then the UE 810 can deactivate the SCell. In some implementations, the predetermined threshold can be a maximum number that comprises any positive integer number greater than 0.

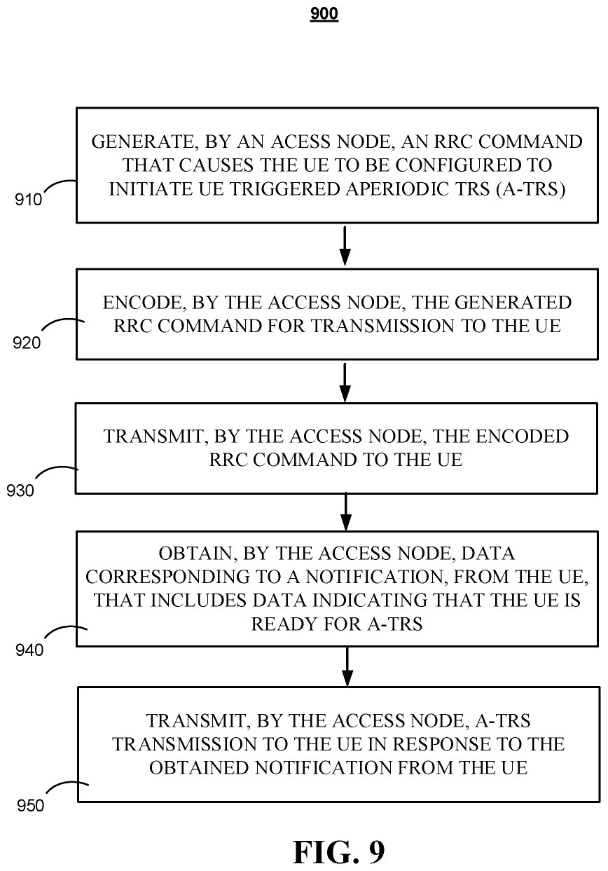

FIG. 9 is a flowchart of a process 900 for fast, direct SCELL activation operations performed by an access node using UE triggered A-TRS in accordance with another aspect of the present disclosure. For convenience, the process 900 will be described below as being performed by an access node such as access node 820.

An access node can being execution of the process 900 by generating 910 an RRC command that causes the UE to be configured to initiate UE triggered aperiodic TRS (A-TRS). In some implementations, the RRC command can include data indicating a candidate A-TRS configuration.

The access node can continue execution of the process 900 by encoding 920 the generated RRC command for transmission to the UE and transmitting 930 the encoded RRC command to the UE.

The access node can continue execution of the process 900 by obtaining 940 data corresponding to a notification, from the UE, that includes data indicating that the UE is ready for A-TRS.

The access node can continue execution of the process 900 by transmitting 950 A-TRS transmissions to the UE in response to the obtained notification from the UE. For implementations where the RRC command includes data indicating a candidate A-TRS configuration, the transmitting of stage 950 can include transmitting A-TRS transmissions to the UE in response to the obtained notification form the UE based on the candidate A-TRS configuration indicated by the RRC command.

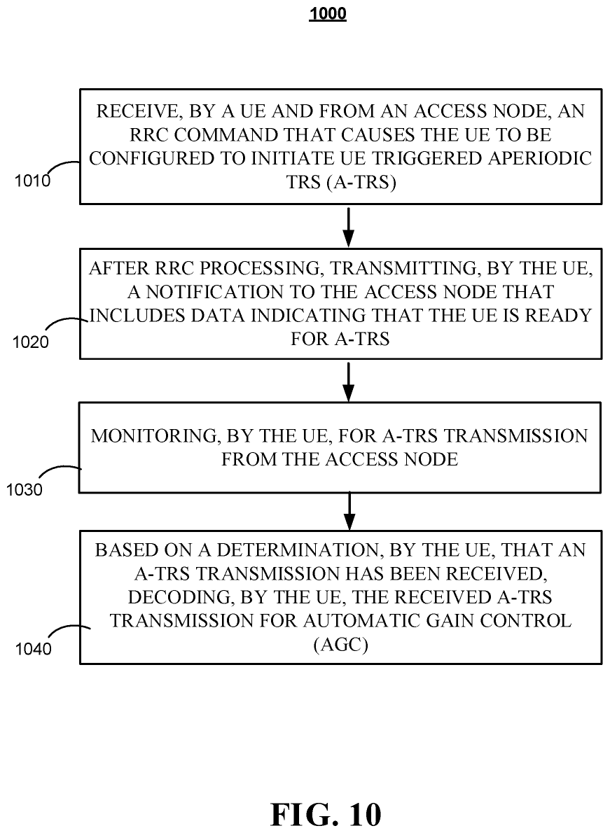

FIG. 10 is a flowchart of a process 1000 for fast, direct SCELL activation operations performed by a UE using UE triggered A-TRS in accordance with another aspect of the present disclosure. For convenience, the process 1000 will be described as being performed by a UE such as the UE 810

A UE can begin execution of the process 1000 by receiving 1010, from an access node, an RRC command that causes the UE to be configured to initiate UE triggered aperiodic TRS (A-TRS). In some implementations, the RRC command can include a candidate A-TRS configuration. In such implementations, the candidate TRS configuration can define a schedule of A-TRS transmissions to be transmitted to the UE by the access node.

After RRC processing, the UE can continue execution of the process 1000 by transmitting 1020 a notification to the access node that includes data indicating that the UE is ready for A-TRS.

The UE can continue execution of the process 1000 by monitoring 1030 for A-TRS transmissions from the access node.

And based on a determination, by the UE, that an A-TRS transmission has been received, the UE can continue execution of the process 1000 by decoding 1040 the received A-TRS transmission for automatic gain control (AGC).

In some implementations, the UE may determine that an A-TRS transmission has not been received. In such implementations, the UE can forgo stage 1040 and transmit another notification to the access node that includes data indicating a request for DCI to trigger A-TRS transmissions.

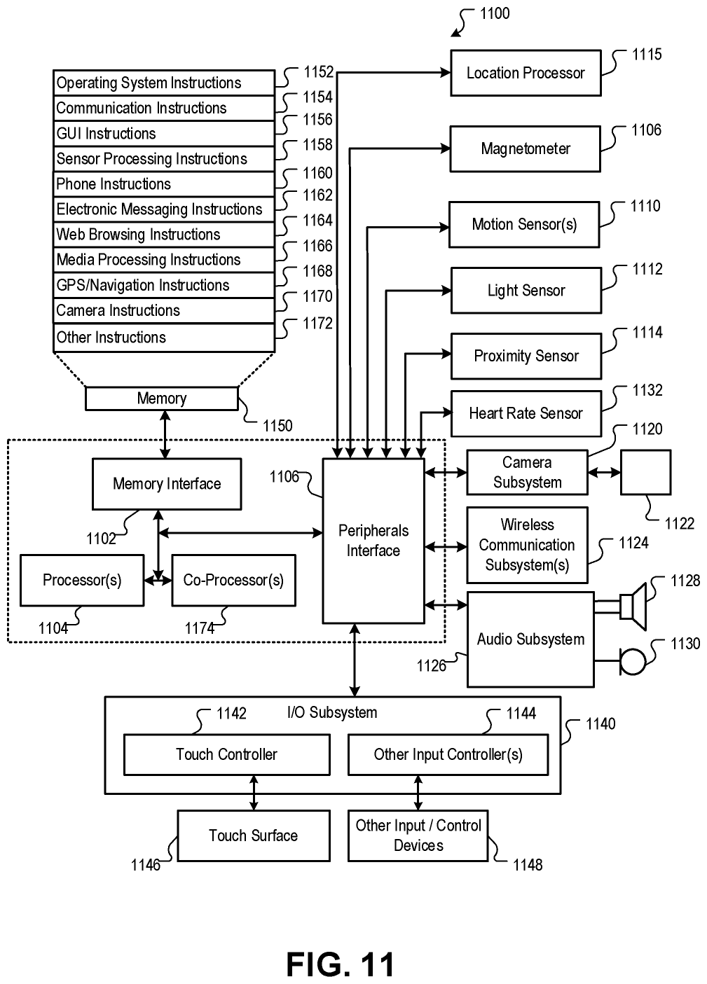

FIG. 11 is a block diagram of an example device architecture 1100 for implementing the features and processes described in reference to FIGS. 1-8. For example, the architecture 1100 can be used to implement a user equipment (UE).

The architecture 1100 can include a memory interface 1102, one or more data processor 1104, one or more data co-processors 1174, and a peripherals interface 1106. The memory interface 1102, the processor(s) 1104, the co-processor(s) 1174, and/or the peripherals interface 1106 can be separate components or can be integrated in one or more integrated circuits. One or more communication buses or signal lines may couple the various components.

The processor(s) 1104 and/or the co-processor(s) 1174 can operate in conjunction to perform the operations described herein. For instance, the processor(s) 1104 can include one or more central processing units (CPUs) that are configured to function as the primary computer processors for the architecture 1100. As an example, the processor(s) 1104 can be configured to perform generalized data processing tasks of the architecture 1100. Further, at least some of the data processing tasks can be offloaded to the co-processor(s) 1174. For example, specialized data processing tasks, such as processing motion data, processing image data, encrypting data, and/or performing certain types of arithmetic operations, can be offloaded to one or more specialized co-processor(s) 1174 for handling those tasks. In some cases, the processor(s) 1104 can be relatively more powerful than the co-processor(s) 1174 and/or can consume more power than the co-processor(s) 1174. This can be useful, for example, as it enables the processor(s) 1104 to handle generalized tasks quickly, while also offloading certain other tasks to co-processor(s) 1174 that may perform those tasks more efficiency and/or more effectively. In some cases, a co-processor(s) can include one or more sensors or other components (e.g., as described herein), and can be configured to process data obtained using those sensors or components, and provide the processed data to the processor(s) 1104 for further analysis.

Sensors, devices, and subsystems can be coupled to peripherals interface 1106 to facilitate multiple functionalities. For example, a motion sensor 1110, a light sensor 1112, and a proximity sensor 1114 can be coupled to the peripherals interface 1106 to facilitate orientation, lighting, and proximity functions of the architecture 1100. For example, in some implementations, a light sensor 1112 can be utilized to facilitate adjusting the brightness of a touch surface 1146. In some implementations, a motion sensor 1110 can be utilized to detect movement and orientation of the device. For example, the motion sensor 1110 can include one or more accelerometers (e.g., to measure the acceleration experienced by the motion sensor 1110 and/or the architecture 1100 over a period of time), and/or one or more compasses or gyros (e.g., to measure the orientation of the motion sensor 1110 and/or the mobile device). In some cases, the measurement information obtained by the motion sensor 1110 can be in the form of one or more a time-varying signals (e.g., a time-varying plot of an acceleration and/or an orientation over a period of time). Further, display objects or media may be presented according to a detected orientation (e.g., according to a “portrait” orientation or a “landscape” orientation). In some cases, a motion sensor 1110 can be directly integrated into a co-processor 1174 configured to processes measurements obtained by the motion sensor 1110. For example, a co-processor 1174 can include one more accelerometers, compasses, and/or gyroscopes, and can be configured to obtain sensor data from each of these sensors, process the sensor data, and transmit the processed data to the processor(s) 1104 for further analysis.

Other sensors may also be connected to the peripherals interface 1106, such as a temperature sensor, a biometric sensor, or other sensing device, to facilitate related functionalities. As an example, as shown in FIG. 11, the architecture 1100 can include a heart rate sensor 1132 that measures the beats of a user's heart. Similarly, these other sensors also can be directly integrated into one or more co-processor(s) 1174 configured to process measurements obtained from those sensors.

A location processor 1115 (e.g., a GNSS receiver chip) can be connected to the peripherals interface 1106 to provide geo-referencing. An electronic magnetometer 1116 (e.g., an integrated circuit chip) can also be connected to the peripherals interface 1106 to provide data that may be used to determine the direction of magnetic North. Thus, the electronic magnetometer 1116 can be used as an electronic compass.

A camera subsystem 1120 and an optical sensor 1122 (e.g., a charged coupled device [CCD] or a complementary metal-oxide semiconductor [CMOS] optical sensor) can be utilized to facilitate camera functions, such as recording photographs and video clips.

Communication functions may be facilitated through one or more communication subsystems 1124. The communication subsystem(s) 1124 can include one or more wireless and/or wired communication subsystems. For example, wireless communication subsystems can include radio frequency receivers and transmitters and/or optical (e.g., infrared) receivers and transmitters. As another example, wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data.

The specific design and implementation of the communication subsystem 1124 can depend on the communication network(s) or medium(s) over which the architecture 1100 is intended to operate. For example, the architecture 1100 can include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, NFC and a Bluetooth™ network. The wireless communication subsystems can also include hosting protocols such that the architecture 1100 can be configured as a base station for other wireless devices. As another example, the communication subsystems 1124 may allow the architecture 1100 to synchronize with a host device using one or more protocols, such as, for example, the TCP/IP protocol, HTTP protocol, UDP protocol, and any other known protocol.

An audio subsystem 1126 can be coupled to a speaker 1128 and one or more microphones 1130 to facilitate voice-enabled functions, such as voice recognition, voice replication, digital recording, and telephony functions.

An I/O subsystem 1140 can include a touch controller 1142 and/or other input controller(s) 1144. The touch controller 1142 can be coupled to a touch surface 1146. The touch surface 1146 and the touch controller 1142 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with the touch surface 1146. In one implementations, the touch surface 1146 can display virtual or soft buttons and a virtual keyboard, which can be used as an input/output device by the user.

Other input controller(s) 1144 can be coupled to other input/control devices 1148, such as one or more buttons, rocker switches, thumb-wheel, infrared port, USB port, and/or a pointer device such as a stylus. The one or more buttons (not shown) can include an up/down button for volume control of the speaker 1128 and/or the microphone 1130.

In some implementations, the architecture 1100 can present recorded audio and/or video files, such as MP3, AAC, and MPEG video files. In some implementations, the architecture 1100 can include the functionality of an MP3 player and may include a pin connector for tethering to other devices. Other input/output and control devices may be used.

A memory interface 1102 can be coupled to a memory 1150. The memory 1150 can include high-speed random access memory or non-volatile memory, such as one or more magnetic disk storage devices, one or more optical storage devices, or flash memory (e.g., NAND, NOR). The memory 1150 can store an operating system 1152, such as Darwin, RTXC. LINUX, UNIX, OS X, WINDOWS, ANDROID, or an embedded operating system such as VxWorks. The operating system 1152 can include instructions for handling basic system services and for performing hardware dependent tasks. In some implementations, the operating system 1152 can include a kernel (e.g., UNIX kernel).

The memory 1150 can also store communication instructions 1154 to facilitate communicating with one or more additional devices, one or more computers or servers, including peer-to-peer communications. The communication instructions 1154 can also be used to select an operational mode or communication medium for use by the device, based on a geographic location (obtained by the GPS/Navigation instructions 1168) of the device. The memory 1150 can include graphical user interface instructions 1156 to facilitate graphic user interface processing, including a touch model for interpreting touch inputs and gestures; sensor processing instructions 1158 to facilitate sensor-related processing and functions; phone instructions 1160 to facilitate phone-related processes and functions; electronic messaging instructions 1162 to facilitate electronic-messaging related processes and functions; web browsing instructions 1164 to facilitate web browsing-related processes and functions; media processing instructions 1166 to facilitate media processing-related processes and functions; GPS/Navigation instructions 1168 to facilitate GPS and navigation-related processes; camera instructions 1170 to facilitate camera-related processes and functions; and other instructions 1172 for performing some or all of the processes described herein.

Each of the above identified instructions and applications can correspond to a set of instructions for performing one or more functions described herein. These instructions need not be implemented as separate software programs, procedures, or modules. The memory 1150 can include additional instructions or fewer instructions. Furthermore, various functions of the device may be implemented in hardware and/or in software, including in one or more signal processing and/or application specific integrated circuits (ASICs).

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

As described above, some aspects of the subject matter of this specification include gathering and use of data available from various sources to improve services a mobile device can provide to a user. The present disclosure contemplates that in some instances, this gathered data may identify a particular location or an address based on device usage. Such personal information data can include location based data, addresses, subscriber account identifiers, or other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In the case of advertisement delivery services, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems.

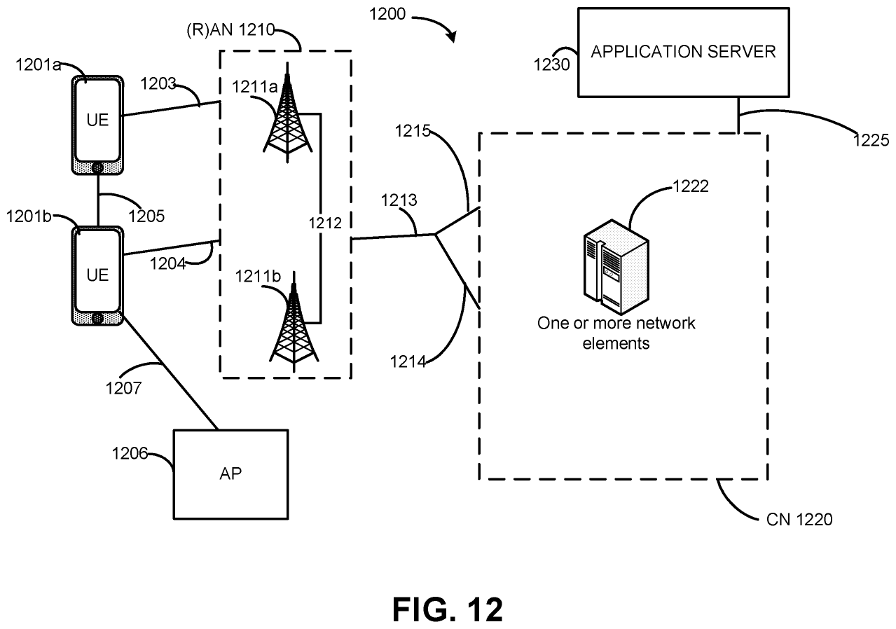

FIG. 12 illustrates an example of a wireless communication system 1200. For purposes of convenience and without limitation, the example system 1200 is described in the context of Long Term Evolution (LTE) and Fifth Generation (5G) New Radio (NR) communication standards as defined by the Third Generation Partnership Project (3GPP) technical specifications. More specifically, the wireless communication system 1200 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless communication system 1200 may also be a Standalone (SA) network that incorporates only NR. Furthermore, other types of communication standards are possible, including future 3GPP systems (e.g., Sixth Generation (6G)) systems, IEEE 802.16 protocols (e.g., WMAN, WiMAX, etc.), or the like.

As shown by FIG. 12, the system 1200 includes UE 1201a and UE 1201b (collectively referred to as “UEs 1201” or “UE 1201”). In this example, UEs 1201 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

In some embodiments, any of the UEs 1201 may be IoT UEs, which may comprise a network access layer designed for low-power IoT applications utilizing short-lived UE connections. An IoT UE can utilize technologies such as M2M or MTC for exchanging data with an MTC server or device via a PLMN, ProSe or D2D communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1201 may be configured to connect, for example, communicatively couple, with RAN 1210. In embodiments, the RAN 1210 may be an NG RAN or a 5G RAN, an E-UTRAN, a non-terrestrial cell, or a legacy RAN, such as a UTRAN or GERAN. As used herein, the term “NG RAN” or the like may refer to a RAN 1210 that operates in an NR or 5G system 1200, and the term “E-UTRAN” or the like may refer to a RAN 1210 that operates in an LTE or 4G system 1200. The UEs 1201 utilize connections (or channels) 1203 and 1204, respectively, each of which comprises a physical communications interface or layer (discussed in further detail below).

In this example, the connections 1203 and 1204 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UEs 1201 may directly exchange communication data via a ProSe interface 1205. The ProSe interface 1205 may alternatively be referred to as a SL interface 1205 and may comprise one or more logical channels, including but not limited to a PSCCH, a PSSCH, a PSDCH, and a PSBCH.

The UE 1201b is shown to be configured to access an AP 1206 (also referred to as “WLAN node 1206,” “WLAN 1206,” “WLAN Termination 1206,” “WT 1206” or the like) via connection 1207. The connection 1207 can comprise a local wireless connection, such as a connection consistent with any IEEE 802.11 protocol, wherein the AP 1206 would comprise a wireless fidelity (Wi-Fi®) router. In this example, the AP 1206 is shown to be connected to the Internet without connecting to the core network of the wireless system (described in further detail below). In various embodiments, the UE 1201b, RAN 1210, and AP 1206 may be configured to utilize LWA operation and/or LWIP operation. The LWA operation may involve the UE 1201b in RRC_CONNECTED being configured by a RAN node 1211a-b to utilize radio resources of LTE and WLAN. LWIP operation may involve the UE 1201b using WLAN radio resources (e.g., connection 1207) via IPsec protocol tunneling to authenticate and encrypt packets (e.g., IP packets) sent over the connection 1207. IPsec tunneling may include encapsulating the entirety of original IP packets and adding a new packet header, thereby protecting the original header of the IP packets.

The RAN 1210 can include one or more AN nodes or RAN nodes 1211a and 1211b (collectively referred to as “RAN nodes 1211” or “RAN node 1211”) that enable the connections 1203 and 1204. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 1211 that operates in an NR or 5G system 1200 (for example, a gNB), and the term “E-UTRAN node” or the like may refer to a RAN node 1211 that operates in an LTE or 4G system 1200 (e.g., an eNB). According to various embodiments, the RAN nodes 1211 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the RAN nodes 1211 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by individual RAN nodes 1211; a MAC/PHY split wherein RRC, PDCP, RLC, and MAC layers are operated by the CRAN/vBBUP and the PHY layer is operated by individual RAN nodes 1211; or a “lower PHY” split wherein RRC, PDCP, RLC, MAC layers and upper portions of the PHY layer are operated by the CRAN/vBBUP and lower portions of the PHY layer are operated by individual RAN nodes 1211. This virtualized framework allows the freed-up processor cores of the RAN nodes 1211 to perform other virtualized applications. In some implementations, an individual RAN node 1211 may represent individual gNB-DUs that are connected to a gNB-CU via individual F1 interfaces (not shown by FIG. 12). In these implementations, the gNB-DUs may include one or more remote radio heads or RFEMs (see, e.g., FIG. 11), and the gNB-CU may be operated by a server that is located in the RAN 1210 (not shown) or by a server pool in a similar manner as the CRAN/vBBUP. Additionally or alternatively, one or more of the RAN nodes 1211 may be next generation eNBs (ng-eNBs), which are RAN nodes that provide E-UTRA user plane and control plane protocol terminations toward the UEs 1201, and are connected to a 5GC via an NG interface (discussed infra).

In V2X scenarios one or more of the RAN nodes 1211 may be or act as RSUs. The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs 1201 (vUEs 1201). The RSU may also include internal data storage circuitry to store intersection map geometry, traffic statistics, media, as well as applications/software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) and/or provide connectivity to one or more cellular networks to provide uplink and downlink communications. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller and/or a backhaul network.

Any of the RAN nodes 1211 can terminate the air interface protocol and can be the first point of contact for the UEs 1201. In some embodiments, any of the RAN nodes 1211 can fulfill various logical functions for the RAN 1210 including, but not limited to, radio network controller (RNC) functions such as radio bearer management, uplink and downlink dynamic radio resource management and data packet scheduling, and mobility management.

In embodiments, the UEs 1201 can be configured to communicate using OFDM communication signals with each other or with any of the RAN nodes 1211 over a multicarrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1211 to the UEs 1201, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various embodiments, the UEs 1201 and the RAN nodes 1211 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the 5 GHz band. NR in the unlicensed spectrum may be referred to as NR-U, and LTE in an unlicensed spectrum may be referred to as LTE-U, licensed assisted access (LAA), or MulteFire.

To operate in the unlicensed spectrum, the UEs 1201 and the RAN nodes 1211 may operate using LAA, eLAA, and/or feLAA mechanisms. In these implementations, the UEs 1201 and the RAN nodes 1211 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

LBT is a mechanism whereby equipment (for example, UEs 1201 RAN nodes 1211, etc.) senses a medium (for example, a channel or carrier frequency) and transmits when the medium is sensed to be idle (or when a specific channel in the medium is sensed to be unoccupied). The medium sensing operation may include CCA, which utilizes at least ED to determine the presence or absence of other signals on a channel in order to determine if a channel is occupied or clear. This LBT mechanism allows cellular/LAA networks to coexist with incumbent systems in the unlicensed spectrum and with other LAA networks. ED may include sensing RF energy across an intended transmission band for a period of time and comparing the sensed RF energy to a predefined or configured threshold.

Typically, the incumbent systems in the 5 GHz band are WLANs based on IEEE 802.11 technologies. WLAN employs a contention-based channel access mechanism, called CSMA/CA. Here, when a WLAN node (e.g., a mobile station (MS) such as UE 1201, AP 1206, or the like) intends to transmit, the WLAN node may first perform CCA before transmission. Additionally, a backoff mechanism is used to avoid collisions in situations where more than one WLAN node senses the channel as idle and transmits at the same time. The backoff mechanism may be a counter that is drawn randomly within the CWS, which is increased exponentially upon the occurrence of collision and reset to a minimum value when the transmission succeeds. The LBT mechanism designed for LAA is somewhat similar to the CSMA/CA of WLAN. In some implementations, the LBT procedure for DL or UL transmission bursts including PDSCH or PUSCH transmissions, respectively, may have an LAA contention window that is variable in length between X and Y ECCA slots, where X and Y are minimum and maximum values for the CWSs for LAA. In one example, the minimum CWS for an LAA transmission may be 9 microseconds(s); however, the size of the CWS and a MCOT (for example, a transmission burst) may be based on governmental regulatory requirements.

The LAA mechanisms are built upon CA technologies of LTE-Advanced systems. In CA, each aggregated carrier is referred to as a CC. A CC may have a bandwidth of 1.4, 3, 5, 10, 15 or 20 MHz and a maximum of five CCs can be aggregated, and therefore, a maximum aggregated bandwidth is 100 MHz. In FDD systems, the number of aggregated carriers can be different for DL and UL, where the number of UL CCs is equal to or lower than the number of DL component carriers. In some cases, individual CCs can have a different bandwidth than other CCs. In TDD systems, the number of CCs as well as the bandwidths of each CC is usually the same for DL and UL.

CA also comprises individual serving cells to provide individual CCs. The coverage of the serving cells may differ, for example, because CCs on different frequency bands will experience different pathloss. A primary service cell or PCell may provide a PCC for both UL and DL, and may handle RRC and NAS related activities. The other serving cells are referred to as SCells, and each SCell may provide an individual SCC for both UL and DL. The SCCs may be added and removed as required, while changing the PCC may require the UE 1201 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH carries user data and higher-layer signaling to the UEs 1201. The PDCCH carries information about the transport format and resource allocations related to the PDSCH channel, among other things. It may also inform the UEs 1201 about the transport format, resource allocation, and HARQ information related to the uplink shared channel. Typically, downlink scheduling (assigning control and shared channel resource blocks to the UE 1201b within a cell) may be performed at any of the RAN nodes 1211 based on channel quality information fed back from any of the UEs 1201. The downlink resource assignment information may be sent on the PDCCH used for (e.g., assigned to) each of the UEs 1201.

The PDCCH uses CCEs to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as REGs. Four Quadrature Phase Shift Keying (QPSK) symbols may be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

The RAN nodes 1211 may be configured to communicate with one another via interface 1212. In embodiments where the system 1200 is an LTE system, the interface 1212 may be an X2 interface 1212. The X2 interface may be defined between two or more RAN nodes 1211 (e.g., two or more eNBs and the like) that connect to EPC 1220, and/or between two eNBs connecting to EPC 1220. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 1201 from an SeNB for user data; information of PDCP PDUs that were not delivered to a UE 1201; information about a current minimum desired buffer size at the SeNB for transmitting to the UE user data; and the like. The X2-C may provide intra-LTE access mobility functionality, including context transfers from source to target eNBs, user plane transport control, etc.; load management functionality; as well as inter-cell interference coordination functionality.

In embodiments where the system 1200 is a 5G or NR system, the interface 1212 may be an Xn interface 1212. The Xn interface is defined between two or more RAN nodes 1211 (e.g., two or more gNBs and the like) that connect to 5GC 1220, between a RAN node 1211 (e.g., a gNB) connecting to 5GC 1220 and an eNB, and/or between two eNBs connecting to 5GC 1220. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 1201 in a connected mode (e.g., CM-CONNECTED) including functionality to manage the UE mobility for connected mode between one or more RAN nodes 1211. The mobility support may include context transfer from an old (source) serving RAN node 1211 to new (target) serving RAN node 1211; and control of user plane tunnels between old (source) serving RAN node 1211 to new (target) serving RAN node 1211. A protocol stack of the Xn-U may include a transport network layer built on Internet Protocol (IP) transport layer, and a GTP-U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In other implementations, the Xn-U protocol stack and/or the Xn-C protocol stack may be same or similar to the user plane and/or control plane protocol stack(s) shown and described herein.

The RAN 1210 is shown to be communicatively coupled to a core network-in this embodiment, core network (CN) 1220. The CN 1220 may comprise a plurality of network elements 1222, which are configured to offer various data and telecommunications services to customers/subscribers (e.g., users of UEs 1201) who are connected to the CN 1220 via the RAN 1210. The components of the CN 1220 may be implemented in one physical node or separate physical nodes including components to read and execute instructions from a machine-readable or computer-readable medium (e.g., a non-transitory machine-readable storage medium). In some embodiments, NFV may be utilized to virtualize any or all of the above-described network node functions via executable instructions stored in one or more computer-readable storage mediums (described in further detail below). A logical instantiation of the CN 1220 may be referred to as a network slice, and a logical instantiation of a portion of the CN 1220 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 1230 may be an element offering applications that use IP bearer resources with the core network (e.g., UMTS PS domain, LTE PS data services, etc.). The application server 1230 can also be configured to support one or more communication services (e.g., VoIP sessions, PTT sessions, group communication sessions, social networking services, etc.) for the UEs 1201 via the EPC 1220.

In embodiments, the CN 1220 may be a 5GC (referred to as “5GC 1220” or the like), and the RAN 1210 may be connected with the CN 1220 via an NG interface 1213. In embodiments, the NG interface 1213 may be split into two parts, an NG user plane (NG-U) interface 1214, which carries traffic data between the RAN nodes 1211 and a UPF, and the S1 control plane (NG-C) interface 1215, which is a signaling interface between the RAN nodes 1211 and AMFs.

In embodiments, the CN 1220 may be a 5G CN (referred to as “5GC 1220” or the like), while in other embodiments, the CN 1220 may be an EPC). Where CN 1220 is an EPC (referred to as “EPC 1220” or the like), the RAN 1210 may be connected with the CN 1220 via an S1 interface 1213. In embodiments, the S1 interface 1213 may be split into two parts, an S1 user plane (S1-U) interface 1214, which carries traffic data between the RAN nodes 1211 and the S-GW, and the S1-MME interface 1215, which is a signaling interface between the RAN nodes 1211 and MMEs.

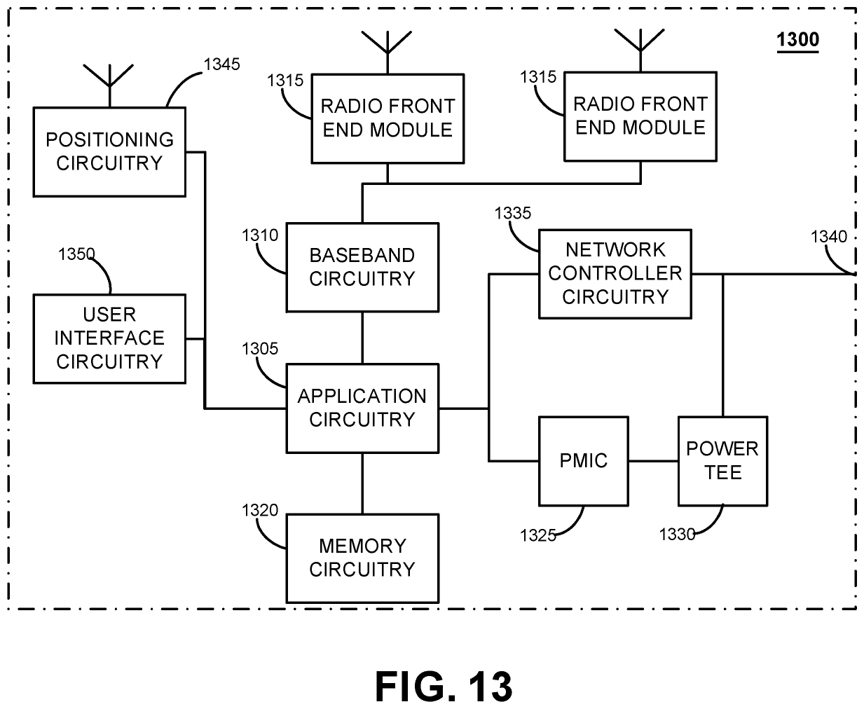

FIG. 13 illustrates an example of infrastructure equipment 1300 in accordance with various embodiments. The infrastructure equipment 1300 (or “system 1300”) may be implemented as a base station, radio head, non-terrestrial base station, RAN node such as the RAN nodes 1211 and/or AP 1206 shown and described previously, application server(s) 1230, and/or any other element/device discussed herein. In other examples, the system 1300 could be implemented in or by a UE.

The system 1300 includes application circuitry 1305, baseband circuitry 1310, one or more radio front end modules (RFEMs) 1315, memory circuitry 1320, power management integrated circuitry (PMIC) 1325, power tee circuitry 1330, network controller circuitry 1335, network interface connector 1340, satellite positioning circuitry 1345, and user interface 1350. In some embodiments, the device 1300 may include additional elements such as, for example, memory/storage, display, camera, sensor, or input/output (I/O) interface. In other embodiments, the components described below may be included in more than one device. For example, said circuitries may be separately included in more than one device for CRAN, vBBU, or other like implementations.

Application circuitry 1305 includes circuitry such as, but not limited to one or more processors (or processor cores), cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 1305 may be coupled with or may include memory/storage elements and may be configured to execute instructions stored in the memory/storage to enable various applications or operating systems to run on the system 1300. In some implementations, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 1305 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some embodiments, the application circuitry 1305 may comprise, or may be, a special-purpose processor/controller to operate according to the various embodiments herein. As examples, the processor(s) of application circuitry 1305 may include one or more may include one or more Apple A-series processors, Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. Such as the ARM Cortex-A family of processors and the ThunderX2® provided by Cavium™, Inc.; a MIPS-based design from MIPS Technologies, Inc. Such as MIPS Warrior P-class processors; and/or the like. In some embodiments, the system 1300 may not utilize application circuitry 1305, and instead may include a special-purpose processor/controller to process IP data received from an EPC or 5GC, for example.

In some implementations, the application circuitry 1305 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In such implementations, the circuitry of application circuitry 1305 may comprise logic blocks or logic fabric, and other interconnected resources that may be programmed to perform various functions, such as the procedures, methods, functions, etc. Of the various embodiments discussed herein. In such embodiments, the circuitry of application circuitry 1305 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. In look-up-tables (LUTs) and the like.

The baseband circuitry 1310 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 1310 are discussed infra with regard to FIG. 12.

User interface circuitry 1350 may include one or more user interfaces designed to enable user interaction with the system 1300 or peripheral component interfaces designed to enable peripheral component interaction with the system 1300. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

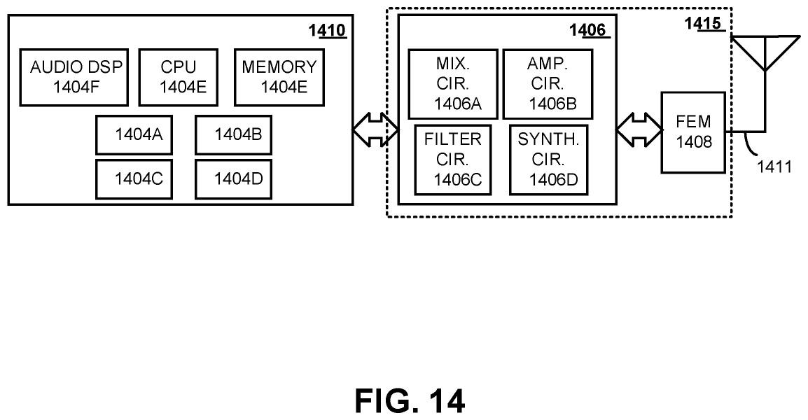

The radio front end modules (RFEMs) 1315 may comprise a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see e.g., antenna array 1411 of FIG. 14 infra), and the RFEM may be connected to multiple antennas. In alternative implementations, both mmWave and sub-mmWave radio functions may be implemented in the same physical RFEM 1315, which incorporates both mmWave antennas and sub-mmWave.

The memory circuitry 1320 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron®. Memory circuitry 1320 may be implemented as one or more of solder down packaged integrated circuits, socketed memory modules and plug-in memory cards.

The PMIC 1325 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 1330 may provide for electrical power drawn from a network cable to provide both power supply and data connectivity to the infrastructure equipment 1300 using a single cable.

The network controller circuitry 1335 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 1300 via network interface connector 1340 using a physical connection, which may be electrical (commonly referred to as a “copper interconnect”), optical, or wireless. The network controller circuitry 1335 may include one or more dedicated processors and/or FPGAs to communicate using one or more of the aforementioned protocols. In some implementations, the network controller circuitry 1335 may include multiple controllers to provide connectivity to other networks using the same or different protocols.

The positioning circuitry 1345 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 1345 comprises various hardware elements (e.g., including hardware devices such as switches, filters, amplifiers, antenna elements, and the like to facilitate OTA communications) to communicate with components of a positioning network, such as navigation satellite constellation nodes. In some embodiments, the positioning circuitry 1345 may include a Micro-Technology for Positioning, Navigation, and Timing (Micro-PNT) IC that uses a master timing clock to perform position tracking/estimation without GNSS assistance. The positioning circuitry 1345 may also be part of, or interact with, the baseband circuitry 1310 and/or RFEMs 1315 to communicate with the nodes and components of the positioning network. The positioning circuitry 1345 may also provide position data and/or time data to the application circuitry 1305, which may use the data to synchronize operations with various infrastructure (e.g., RAN nodes 1211, etc.), or the like.

The components shown by FIG. 13 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

FIG. 14 illustrates example components of baseband circuitry 1410 and radio front end modules (RFEM) 1415 in accordance with various embodiments. The baseband circuitry 1410 corresponds to the baseband circuitry 1310 of FIG. 13. The RFEM 1415 corresponds to the RFEM 1315 of FIG. 13. As shown, the RFEMs 1415 may include Radio Frequency (RF) circuitry 1406, front-end module (FEM) circuitry 1408, antenna array 1411 coupled together at least as shown.

The baseband circuitry 1410 includes circuitry and/or control logic configured to carry out various radio/network protocol and radio control functions that enable communication with one or more radio networks via the RF circuitry 1406. The radio control functions may include, but are not limited to, signal modulation/demodulation, encoding/decoding, radio frequency shifting, etc. In some embodiments, modulation/demodulation circuitry of the baseband circuitry 1410 may include Fast-Fourier Transform (FFT), precoding, or constellation mapping/demapping functionality. In some embodiments, encoding/decoding circuitry of the baseband circuitry 1410 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments. The baseband circuitry 1410 is configured to process baseband signals received from a receive signal path of the RF circuitry 1406 and to generate baseband signals for a transmit signal path of the RF circuitry 1406. The baseband circuitry 1410 is configured to interface with application circuitry 1305 (see FIG. 13) for generation and processing of the baseband signals and for controlling operations of the RF circuitry 1406. The baseband circuitry 1410 may handle various radio control functions.

The aforementioned circuitry and/or control logic of the baseband circuitry 1410 may include one or more single or multi-core processors. For example, the one or more processors may include a 3G baseband processor 1404A, a 4G/LTE baseband processor 1404B, a 5G/NR baseband processor 1404C, or some other baseband processor(s) 1404D for other existing generations, generations in development or to be developed in the future (e.g., sixth generation (6G), etc.). In other embodiments, some or all of the functionality of baseband processors 1404A-D may be included in modules stored in the memory 1404G and executed via a Central Processing Unit (CPU) 1404E. In other embodiments, some or all of the functionality of baseband processors 1404A-D may be provided as hardware accelerators (e.g., FPGAs, ASICs, etc.) loaded with the appropriate bit streams or logic blocks stored in respective memory cells. In various embodiments, the memory 1404G may store program code of a real-time OS (RTOS), which when executed by the CPU 1404E (or other baseband processor), is to cause the CPU 1404E (or other baseband processor) to manage resources of the baseband circuitry 1410, schedule tasks, etc. Examples of the RTOS may include Operating System Embedded (OSE)™ provided by Enea®, Nucleus RTOS™ provided by Mentor Graphics®, Versatile Real-Time Executive (VRTX) provided by Mentor Graphics®, ThreadX™ provided by Express Logic®, FreeRTOS, REX OS provided by Qualcomm®, OKL4 provided by Open Kernel (OK) Labs®, or any other suitable RTOS, such as those discussed herein. In addition, the baseband circuitry 1410 includes one or more audio digital signal processor(s) (DSP) 1404F. The audio DSP(s) 1404F include elements for compression/decompression and echo cancellation and may include other suitable processing elements in other embodiments.

In some embodiments, each of the processors 1404A-1204E include respective memory interfaces to send/receive data to/from the memory 1404G. The baseband circuitry 1410 may further include one or more interfaces to communicatively couple to other circuitries/devices, such as an interface to send/receive data to/from memory external to the baseband circuitry 1410; an application circuitry interface to send/receive data to/from the application circuitry 1305 of FIG. 13); an RF circuitry interface to send/receive data to/from RF circuitry 1406 of FIG. 14; a wireless hardware connectivity interface to send/receive data to/from one or more wireless hardware elements (e.g., Near Field Communication (NFC) components, Bluetooth®/Bluetooth® Low Energy components, Wi-Fi® components, and/or the like); and a power management interface to send/receive power or control signals to/from a PMIC.

In alternate embodiments (which may be combined with the above described embodiments), baseband circuitry 1410 comprises one or more digital baseband systems, which are coupled with one another via an interconnect subsystem and to a CPU subsystem, an audio subsystem, and an interface subsystem. The digital baseband subsystems may also be coupled to a digital baseband interface and a mixed-signal baseband subsystem via another interconnect subsystem. Each of the interconnect subsystems may include a bus system, point-to-point connections, network-on-chip (NOC) structures, and/or some other suitable bus or interconnect technology, such as those discussed herein. The audio subsystem may include DSP circuitry, buffer memory, program memory, speech processing accelerator circuitry, data converter circuitry such as analog-to-digital and digital-to-analog converter circuitry, analog circuitry including one or more of amplifiers and filters, and/or other like components. In an aspect of the present disclosure, baseband circuitry 1410 may include protocol processing circuitry with one or more instances of control circuitry (not shown) to provide control functions for the digital baseband circuitry and/or radio frequency circuitry (e.g., the radio front end modules 1415).

Although not shown by FIG. 14, in some embodiments, the baseband circuitry 1410 includes individual processing device(s) to operate one or more wireless communication protocols (e.g., a “multi-protocol baseband processor” or “protocol processing circuitry”) and individual processing device(s) to implement PHY layer functions. In these embodiments, the PHY layer functions include the aforementioned radio control functions. In these embodiments, the protocol processing circuitry operates or implements various protocol layers/entities of one or more wireless communication protocols. In a first example, the protocol processing circuitry may operate LTE protocol entities and/or 5G/NR protocol entities when the baseband circuitry 1410 and/or RF circuitry 1406 are part of mmWave communication circuitry or some other suitable cellular communication circuitry. In the first example, the protocol processing circuitry would operate MAC, RLC, PDCP, SDAP. RRC, and NAS functions. In a second example, the protocol processing circuitry may operate one or more IEEE-based protocols when the baseband circuitry 1410 and/or RF circuitry 1406 are part of a Wi-Fi communication system. In the second example, the protocol processing circuitry would operate Wi-Fi MAC and logical link control (LLC) functions. The protocol processing circuitry may include one or more memory structures (e.g., 1404) to store program code and data for operating the protocol functions, as well as one or more processing cores to execute the program code and perform various operations using the data. The baseband circuitry 1410 may also support radio communications for more than one wireless protocol.

The various hardware elements of the baseband circuitry 1410 discussed herein may be implemented, for example, as a solder-down substrate including one or more integrated circuits (ICs), a single packaged IC soldered to a main circuit board or a multi-chip module containing two or more ICs. In one example, the components of the baseband circuitry 1410 may be suitably combined in a single chip or chipset, or disposed on a same circuit board. In another example, some or all of the constituent components of the baseband circuitry 1410 and RF circuitry 1406 may be implemented together such as, for example, a system on a chip (SoC) or System-in-Package (SiP). In another example, some or all of the constituent components of the baseband circuitry 1410 may be implemented as a separate SoC that is communicatively coupled with and RF circuitry 1406 (or multiple instances of RF circuitry 1406). In yet another example, some or all of the constituent components of the baseband circuitry 1410 and the application circuitry 1305 may be implemented together as individual SoCs mounted to a same circuit board (e.g., a “multi-chip package”).

In some embodiments, the baseband circuitry 1410 may provide for communication compatible with one or more radio technologies. For example, in some embodiments, the baseband circuitry 1410 may support communication with an E-UTRAN or other WMAN, a WLAN, a WPAN. Embodiments in which the baseband circuitry 1410 is configured to support radio communications of more than one wireless protocol may be referred to as multi-mode baseband circuitry.

RF circuitry 1406 may enable communication with wireless networks using modulated electromagnetic radiation through a non-solid medium. In various embodiments, the RF circuitry 1406 may include switches, filters, amplifiers, etc. To facilitate the communication with the wireless network. RF circuitry 1406 may include a receive signal path, which may include circuitry to down-convert RF signals received from the FEM circuitry 1408 and provide baseband signals to the baseband circuitry 1410. RF circuitry 1406 may also include a transmit signal path, which may include circuitry to up-convert baseband signals provided by the baseband circuitry 1410 and provide RF output signals to the FEM circuitry 1408 for transmission.

In some embodiments, the receive signal path of the RF circuitry 1406 may include mixer circuitry 1406a, amplifier circuitry 1406b and filter circuitry 1406c. In some embodiments, the transmit signal path of the RF circuitry 1406 may include filter circuitry 1406c and mixer circuitry 1406a. RF circuitry 1406 may also include synthesizer circuitry 1406d for synthesizing a frequency for use by the mixer circuitry 1406a of the receive signal path and the transmit signal path. In some embodiments, the mixer circuitry 1406a of the receive signal path may be configured to down-convert RF signals received from the FEM circuitry 1408 based on the synthesized frequency provided by synthesizer circuitry 1406d. The amplifier circuitry 1406b may be configured to amplify the down-converted signals and the filter circuitry 1406c may be a low-pass filter (LPF) or band-pass filter (BPF) configured to remove unwanted signals from the down-converted signals to generate output baseband signals. Output baseband signals may be provided to the baseband circuitry 1410 for further processing. In some embodiments, the output baseband signals may be zero-frequency baseband signals, although this is not a requirement. In some embodiments, mixer circuitry 1406a of the receive signal path may comprise passive mixers, although the scope of the embodiments is not limited in this respect.

In some embodiments, the mixer circuitry 1406a of the transmit signal path may be configured to up-convert input baseband signals based on the synthesized frequency provided by the synthesizer circuitry 1406d to generate RF output signals for the FEM circuitry 1408. The baseband signals may be provided by the baseband circuitry 1410 and may be filtered by filter circuitry 1406c.

In some embodiments, the mixer circuitry 1406a of the receive signal path and the mixer circuitry 1406a of the transmit signal path may include two or more mixers and may be arranged for quadrature downconversion and upconversion, respectively. In some embodiments, the mixer circuitry 1406a of the receive signal path and the mixer circuitry 1406a of the transmit signal path may include two or more mixers and may be arranged for image rejection (e.g., Hartley image rejection). In some embodiments, the mixer circuitry 1406a of the receive signal path and the mixer circuitry 1406a of the transmit signal path may be arranged for direct downconversion and direct upconversion, respectively. In some embodiments, the mixer circuitry 1406a of the receive signal path and the mixer circuitry 1406a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1406 may include analog-to-digital converter (ADC) and digital-to-analog converter (DAC) circuitry and the baseband circuitry 1410 may include a digital baseband interface to communicate with the RF circuitry 1406.

In some dual-mode embodiments, a separate radio IC circuitry may be provided for processing signals for each spectrum, although the scope of the embodiments is not limited in this respect.

In some embodiments, the synthesizer circuitry 1406d may be a fractional-N synthesizer or a fractional N/N+1 synthesizer, although the scope of the embodiments is not limited in this respect as other types of frequency synthesizers may be suitable. For example, synthesizer circuitry 1406d may be a delta-sigma synthesizer, a frequency multiplier, or a synthesizer comprising a phase-locked loop with a frequency divider.

The synthesizer circuitry 1406d may be configured to synthesize an output frequency for use by the mixer circuitry 1406a of the RF circuitry 1406 based on a frequency input and a divider control input. In some embodiments, the synthesizer circuitry 1406d may be a fractional N/N+1 synthesizer.

In some embodiments, frequency input may be provided by a voltage controlled oscillator (VCO), although that is not a requirement. Divider control input may be provided by either the baseband circuitry 1410 or the application circuitry 1305 depending on the desired output frequency. In some embodiments, a divider control input (e.g., N) may be determined from a look-up table based on a channel indicated by the application circuitry 1305.

Synthesizer circuitry 1406d of the RF circuitry 1406 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1406d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1406 may include an IQ/polar converter.

FEM circuitry 1408 may include a receive signal path, which may include circuitry configured to operate on RF signals received from antenna array 1411, amplify the received signals and provide the amplified versions of the received signals to the RF circuitry 1406 for further processing. FEM circuitry 1408 may also include a transmit signal path, which may include circuitry configured to amplify signals for transmission provided by the RF circuitry 1406 for transmission by one or more of antenna elements of antenna array 1411. In various embodiments, the amplification through the transmit or receive signal paths may be done solely in the RF circuitry 1406, solely in the FEM circuitry 1408, or in both the RF circuitry 1406 and the FEM circuitry 1408.

In some embodiments, the FEM circuitry 1408 may include a TX/RX switch to switch between transmit mode and receive mode operation. The FEM circuitry 1408 may include a receive signal path and a transmit signal path. The receive signal path of the FEM circuitry 1408 may include an LNA to amplify received RF signals and provide the amplified received RF signals as an output (e.g., to the RF circuitry 1406). The transmit signal path of the FEM circuitry 1408 may include a power amplifier (PA) to amplify input RF signals (e.g., provided by RF circuitry 1406), and one or more filters to generate RF signals for subsequent transmission by one or more antenna elements of the antenna array 1411.

The antenna array 1411 comprises one or more antenna elements, each of which is configured convert electrical signals into radio waves to travel through the air and to convert received radio waves into electrical signals. For example, digital baseband signals provided by the baseband circuitry 1410 is converted into analog RF signals (e.g., modulated waveform) that will be amplified and transmitted via the antenna elements of the antenna array 1411 including one or more antenna elements (not shown). The antenna elements may be omnidirectional, direction, or a combination thereof. The antenna elements may be formed in a multitude of arranges as are known and/or discussed herein. The antenna array 1411 may comprise microstrip antennas or printed antennas that are fabricated on the surface of one or more printed circuit boards. The antenna array 1411 may be formed in as a patch of metal foil (e.g., a patch antenna) in a variety of shapes, and may be coupled with the RF circuitry 1406 and/or FEM circuitry 1408 using metal transmission lines or the like.

Processors of the application circuitry 1305 and processors of the baseband circuitry 1410 may be used to execute elements of one or more instances of a protocol stack. For example, processors of the baseband circuitry 1410, alone or in combination, may be used execute Layer 3, Layer 2, or Layer 1 functionality, while processors of the application circuitry 1305 may utilize data (e.g., packet data) received from these layers and further execute Layer 4 functionality (e.g., TCP and UDP layers). As referred to herein, Layer 3 may comprise a RRC layer, described in further detail below. As referred to herein, Layer 2 may comprise a MAC layer, an RLC layer, and a PDCP layer, described in further detail below. As referred to herein, Layer 1 may comprise a PHY layer of a UE/RAN node, described in further detail below.

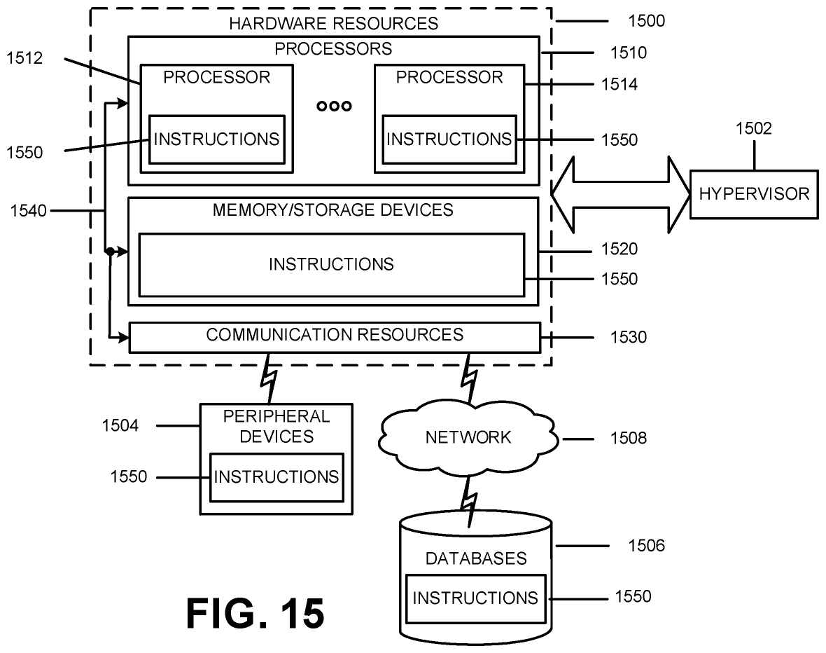

FIG. 15 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540. For embodiments where node virtualization (e.g., NFV) is utilized, a hypervisor 1502 may be executed to provide an execution environment for one or more network slices/sub-slices to utilize the hardware resources 1500.

The processors 1510 may include, for example, a processor 1512 and a processor 1514. The processor(s) 1510 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1520 may include main memory, disk storage, or any suitable combination thereof. The memory/storage devices 1520 may include, but are not limited to, any type of volatile or nonvolatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1530 may include interconnection or network interface components or other suitable devices to communicate with one or more peripheral devices 1504 or one or more databases 1506 via a network 1508. For example, the communication resources 1530 may include wired communication components (e.g., for coupling via USB), cellular communication components, NFC components, Bluetooth® (or Bluetooth® Low Energy) components, Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method for direct SCell activation, the method comprising:
receiving, by a UE, an RRC command that causes the UE to be configured to detect a TRS transmission of a plurality of TRS transmission bursts broadcast by an access node;
disregarding, by the UE, one or more TRS transmission of the plurality of TRS transmission bursts that are received, by the UE, during processing of the received RRC command; and
after processing, by the UE, of the received RRC command, decoding, by the UE, a TRS transmission of the plurality of TRS transmission bursts that was received subsequent to completion of processing of the received RRC command for automatic gain control (AGC).

2. The method of claim 1, wherein each TRS transmission burst includes a plurality of TRS transmissions.

3. The method of claim 1, wherein decoding, by the UE, a TRS transmission of the plurality of TRS transmission bursts that is received subsequent to completion of processing of the received RRC command for AGC comprises:
decoding, by the UE, a first TRS transmission of the plurality of TRS transmission bursts that is received subsequent to completion of processing of the received RRC command for AGC.

4. The method of claim 1, the method further comprising:
decoding another TRS transmission of the plurality of TRS transmission bursts that is received subsequent to completion of processing of the received RRC command and completion of AGC for T/F tracking.

5. The method of claim 1, wherein the received RRC command further includes data corresponding to an offset value, wherein the offset value is specified in units of slot relative to the slot in which the RRC command was received.

6. The method of claim 1, wherein the received RRC command further includes data that causes the UE to enable SP-TRS activation.

7. The method of claim 1, the method further comprising:
receiving, by the UE and subsequent to decoding of (1) a TRS transmission for AGC and (2) a TRS transmission for T/F tracking, a MAC-CE that includes data that configures the UE to deactivate SP-TRS.

8. A user equipment (UE) for direct SCell activation comprising:
one or more processors; and
one or more memory devices storing instructions that, when executed by the one or more processors, cause the UE to perform operations, the operations comprising:
receiving, by the UE, an RRC command that causes the UE to be configured to detect a TRS transmission of a plurality of TRS transmission bursts broadcast by an access node;
disregarding, by the UE, one or more TRS transmission of the plurality of TRS transmission bursts that are received, by the UE, during processing of the received RRC command; and
after processing, by the UE, of the received RRC command, decoding, by the UE, a TRS transmission of the plurality of TRS transmission bursts that was received subsequent to completion of processing of the received RRC command for automatic gain control (AGC).

9. The UE of claim 8, wherein each TRS transmission burst includes a plurality of TRS transmissions.

10. The UE of claim 8, wherein decoding, by the UE, a TRS transmission of the plurality of TRS transmission bursts that is received subsequent to completion of processing of the received RRC command for AGC comprises:
decoding, by the UE, a first TRS transmission of the plurality of TRS transmission bursts that is received subsequent to completion of processing of the received RRC command for AGC.

11. The UE of claim 8, the operations further comprising:
decoding, by the UE, another TRS transmission of the plurality of TRS transmission bursts that is received subsequent to completion of processing of the received RRC command and completion of AGC for T/F tracking.

12. The UE of claim 8, wherein the received RRC command further includes data corresponding to an offset value, wherein the offset value is specified in units of slot relative to the slot in which the RRC command was received.

13. The UE of claim 8, wherein the received RRC command further includes data that causes the UE to enable SP-TRS activation.

14. The UE of claim 8, the operations further comprising:
receiving, by the UE and subsequent to decoding of (1) a TRS transmission for AGC and (2) a TRS transmission for T/F tracking, a MAC-CE that includes data that configures the UE to deactivate SP-TRS.

15. One or more computer readable storage media storing instructions that, when executed by one or more processors, causes the one or more processors of user equipment (UE) to perform operations, the operations comprising:
receiving an RRC command that causes the UE to be configured to detect a TRS transmission of a plurality of TRS transmission bursts broadcast by an access node;
disregarding one or more TRS transmission of the plurality of TRS transmission bursts that are received during processing of the received RRC command; and
after processing of the received RRC command, decoding a TRS transmission of the plurality of TRS transmission bursts that was received subsequent to completion of processing of the received RRC command for automatic gain control (AGC).

16. The computer readable storage media of claim 15, wherein each TRS transmission burst includes a plurality of TRS transmissions.

17. The computer readable storage media of claim 15, wherein decoding a TRS transmission of the plurality of TRS transmission bursts that is received subsequent to completion of processing of the received RRC command for AGC comprises:
decoding a first TRS transmission of the plurality of TRS transmission bursts that is received subsequent to completion of processing of the received RRC command for AGC.

18. The computer readable storage media of claim 15, the operations further comprising:
decoding another TRS transmission of the plurality of TRS transmission bursts that is received subsequent to completion of processing of the received RRC command and completion of AGC for T/F tracking.

19. The computer readable storage media of claim 15, wherein the received RRC command further includes data corresponding to an offset value, wherein the offset value is specified in units of slot relative to the slot in which the RRC command was received.

20. The computer readable storage media of claim 15, wherein the received RRC command further includes data that causes the UE to enable SP-TRS activation.

21. The computer readable storage media of claim 15, the operations further comprising:
receiving, subsequent to decoding of (1) a TRS transmission for AGC and (2) a TRS transmission for T/F tracking, a MAC-CE that includes data that configures the UE to deactivate SP-TRS.

22. A method for direct SCell activation, the method comprising:
generating, by an access node, an RRC command that includes one or more parameters that, when processed by a UE, cause the UE to be configured to detect a TRS transmission of a plurality of TRS transmission bursts broadcast by the access node;
encoding, by the access node, the generated RRC command for transmission to the UE;
transmitting, by the access node, the encoded RRC command to the UE; and
after transmitting the encoded RRC command to the UE, transmitting, by the access node, a plurality of TRS transmission bursts to the UE.

23. The method of claim 22, wherein after transmitting the encoded RRC command to the UE, transmitting, by the access node, a plurality of TRS transmission bursts to the UE comprises:
based on a determination that a predetermined amount of time has expired after transmitting the encoded RRC command to the UE, transmitting, by the access node, a plurality of TRS transmission bursts to the UE.

24. The method of claim 22, wherein after transmitting the encoded RRC command to the UE, transmitting, by the access node, a plurality of TRS transmission bursts to the UE comprises:
based on a determination that the RRC process has been completed by the UE, transmitting, by the access node, a plurality of TRS transmission bursts to the UE.

25. The method of claim 22, wherein each TRS transmission burst includes a plurality of TRS transmissions.

26. The method of claim 22, wherein the generated RRC command includes data that indicates that there will be a plurality of TRS transmission bursts broadcast by the access node after RRC configuration.

27. The method of claim 22, wherein the generated RRC command includes data that indicates a TRS configuration.

28. The method of claim 22, the method further comprising:
receiving, by the access node, a CSI report notification from the UE after CSI measurement has been completed by the UE.

29. The method of claim 22, wherein the generated RRC command further includes a data corresponding to an offset value, wherein the offset value is specified in units of slot relative to the slot in which the RRC command was received.

30. The method of claim 22, wherein the generated RRC command further includes data that causes the UE to enable SP-TRS activation.

31. The method of claim 22, the method further comprising:
generating, by the access node and after receipt of a CSI report notification from the UE, a MAC-CE that includes data that configures the UE to deactivate SP-TRS;
encoding, by the access node, the generated MAC-CE for transmission to the UE; and
transmitting, by the access node, the encoded MAC-CE to the UE.

32. An access node for direct SCell activation comprising:
one or more processors; and
one or more memory devices storing instructions that, when executed by the one or more processors, cause the access node to perform operations, the operations comprising:
generating, by the access node, an RRC command that includes one or more parameters that, when processed by a UE, cause the UE to be configured to detect a TRS transmission of a plurality of TRS transmission bursts broadcast by the access node;
encoding, by the access node, the generated RRC command for transmission to the UE;
transmitting, by the access node, the encoded RRC command to the UE; and
after transmitting the encoded RRC command to the UE, transmitting, by the access node, a plurality of TRS transmission bursts to the UE.

33. The access node of claim 32, wherein after transmitting the encoded RRC command to the UE, transmitting, by the access node, a plurality of TRS transmission bursts to the UE comprises:
based on a determination that a predetermined amount of time has expired after transmitting the encoded RRC command to the UE, transmitting, by the access node, a plurality of TRS transmission bursts to the UE.

34. The access node of claim 32, wherein after transmitting the encoded RRC command to the UE, transmitting, by the access node, a plurality of TRS transmission bursts to the UE comprises:
based on a determination that the RRC process has been completed by the UE, transmitting, by the access node, a plurality of TRS transmission bursts to the UE.

35. The access node of claim 32, wherein each TRS transmission burst includes a plurality of TRS transmissions.

36. The access node of claim 32, wherein the generated RRC command includes data that indicates that there will be a plurality of TRS transmission bursts broadcast by the access node after RRC configuration.

37. The access node of claim 32, wherein the generated RRC command includes data that indicates a TRS configuration.

38. The access node of claim 32, the operations further comprising:
receiving, by the access node, a CSI report notification from the UE after CSI measurement has been completed by the UE.

39. The access node of claim 32, wherein the generated RRC command further includes a data corresponding to an offset value, wherein the offset value is specified in units of slot relative to the slot in which the RRC command was received.

40. The access node of claim 32, wherein the generated RRC command further includes data that causes the UE to enable SP-TRS activation.

41. The access node of claim 32, the operations further comprising:
generating, by the access node and after receipt of a CSI report notification from the UE, a MAC-CE that includes data that configures the UE to deactivate SP-TRS;
encoding, by the access node, the generated MAC-CE for transmission to the UE; and
transmitting, by the access node, the encoded MAC-CE to the UE.

42. One or more computer readable storage media storing instructions that, when executed by one or more processors, causes the one or more processors of an access node to perform operations, the operations comprising:
generating an RRC command that includes one or more parameters that, when processed by a UE, cause the UE to be configured to detect a TRS transmission of a plurality of TRS transmission bursts broadcast by the access node;
encoding the generated RRC command for transmission to the UE;
transmitting the encoded RRC command to the UE; and
after transmitting the encoded RRC command to the UE, transmitting a plurality of TRS transmission bursts to the UE.

43. The computer readable storage media of claim 42, wherein after transmitting the encoded RRC command to the UE, transmitting a plurality of TRS transmission bursts to the UE comprises:
based on a determination that a predetermined amount of time has expired after transmitting the encoded RRC command to the UE, transmitting a plurality of TRS transmission bursts to the UE.

44. The computer readable storage media of claim 42, wherein after transmitting the encoded RRC command to the UE, transmitting a plurality of TRS transmission bursts to the UE comprises:
based on a determination that the RRC process has been completed by the UE, transmitting a plurality of TRS transmission bursts to the UE.

45. The computer readable storage media of claim 42, wherein each TRS transmission burst includes a plurality of TRS transmissions.

46. The computer readable storage media of claim 42, wherein the generated RRC command includes data that indicates that there will be a plurality of TRS transmission bursts broadcast by the access node after RRC configuration.

47. The computer readable storage media of claim 42, wherein the generated RRC command includes data that indicates a TRS configuration.

48. The computer readable storage media of claim 42, the operations further comprising:
receiving a CSI report notification from the UE after CSI measurement has been completed by the UE.

49. The computer readable storage media of claim 42, wherein the generated RRC command further includes a data corresponding to an offset value, wherein the offset value is specified in units of slot relative to the slot in which the RRC command was received.

50. The computer readable storage media of claim 42, wherein the generated RRC command further includes data that causes the UE to enable SP-TRS activation.

51. The computer readable storage media of claim 42, the operations further comprising:
generating, after receipt of a CSI report notification from the UE, a MAC-CE that includes data that configures the UE to deactivate SP-TRS;
encoding the generated MAC-CE for transmission to the UE; and
transmitting the encoded MAC-CE to the UE.

52. A method for direct SCell activation, the method comprising:
receiving, by a UE and from an access node, an RRC command that causes the UE to be configured to initiate UE triggered aperiodic TRS (A-TRS);
after RRC processing, transmitting, by the UE, a notification to the access node that includes data indicating that the UE is ready for A-TRS;
monitoring, by the UE, for A-TRS transmissions from the access node; and
based on a determination, by the UE, that an A-TRS transmission has been received, decoding the received A-TRS transmission for automatic gain control (AGC).

53. The method of claim 1, the method further comprising:
based on a determination, by the UE, that an A-TRS transmission has not been received, transmitting another notification to the access node that includes data indicating a request for DCI to trigger A-TRS transmissions.

54. The method of claim 1, wherein the RRC command includes a candidate A-TRS configuration.

55. The method of claim 1, wherein the candidate TRS configuration defines a schedule of A-TRS transmissions to be transmitted to the UE by the access node.

56. The method of claim 1, the method further comprising:
decoding, by the UE, another A-TRS transmission that is received subsequent to completion of processing of completion of AGC for T/F tracking.

57. The method of claim 1, the method further comprising:
decoding, by the UE, another A-TRS transmission that is received subsequent to completion of processing of completion of AGC and completion of T/F tracking for CSI measurement.

58. The method of claim 1, the method further comprising:
transmitting, by the UE, a CSI report to the access node.

59. A user equipment (UE) for direct SCell activation comprising:
one or more processors; and
one or more memory devices storing instructions that, when executed by the one or more processors, cause the UE to perform operations, the operations comprising:
receiving, by the UE and from an access node, an RRC command that causes the UE to be configured to initiate UE triggered aperiodic TRS (A-TRS);
after RRC processing, transmitting, by the UE, a notification to the access node that includes data indicating that the UE is ready for A-TRS;
monitoring, by the UE, for A-TRS transmissions from the access node; and
based on a determination, by the UE, that an A-TRS transmission has been received, decoding the received A-TRS transmission for automatic gain control (AGC).

60. The UE of claim 59, the operations further comprising:
based on a determination, by the UE, that an A-TRS transmission has not been received, transmitting another notification to the access node that includes data indicating a request for DCI to trigger A-TRS transmissions.

61. The UE of claim 59, wherein the RRC command includes a candidate A-TRS configuration.

62. The UE of claim 59, wherein the candidate TRS configuration defines a schedule of A-TRS transmissions to be transmitted to the UE by the access node.

63. The UE of claim 59, the operations further comprising:
decoding, by the UE, another A-TRS transmission that is received subsequent to completion of processing of completion of AGC for T/F tracking.

64. The UE of claim 59, the operations further comprising:
decoding, by the UE, another A-TRS transmission that is received subsequent to completion of processing of completion of AGC and completion of T/F tracking for CSI measurement.

65. The UE of claim 59, the operations further comprising:
transmitting, by the UE, a CSI report to the access node.

66. One or more computer readable storage media storing instructions that, when executed by one or more processors, causes the one or more processors of user equipment (UE) to perform operations, the operations comprising:
receiving, from an access node, an RRC command that causes the UE to be configured to initiate UE triggered aperiodic TRS (A-TRS);
after RRC processing, transmitting a notification to the access node that includes data indicating that the UE is ready for A-TRS;
monitoring for A-TRS transmissions from the access node; and
based on a determination that an A-TRS transmission has been received, decoding the received A-TRS transmission for automatic gain control (AGC).

67. The computer readable media of claim 66, the operations further comprising:
based on a determination that an A-TRS transmission has not been received, transmitting another notification to the access node that includes data indicating a request for DCI to trigger A-TRS transmissions.

68. The computer readable media of claim 66, wherein the RRC command includes a candidate A-TRS configuration.

69. The computer readable media of claim 66, wherein the candidate TRS configuration defines a schedule of A-TRS transmissions to be transmitted to the UE by the access node.

70. The computer readable media of claim 66, the operations further comprising:
decoding another A-TRS transmission that is received subsequent to completion of processing of completion of AGC for T/F tracking.

71. The computer readable media of claim 66, the operations further comprising:
decoding another A-TRS transmission that is received subsequent to completion of processing of completion of AGC and completion of T/F tracking for CSI measurement.

72. The computer readable media of claim 66, the operations further comprising:
transmitting a CSI report to the access node.

73. A method for direct SCell activation, the method comprising:
generating, by an access node, an RRC command that causes the UE to be configured to initiate UE triggered aperiodic TRS (A-TRS);
encoding, by the access node, the generated RRC command for transmission to the UE;
transmitting, by the access node, the encoded RRC command to the UE;
obtaining, by the access node, data corresponding to a notification, from the UE, that includes data indicating that the UE is ready for A-TRS; and
transmitting, by the access node, TRS transmissions to the UE in response to the obtained notification from the UE.

74. The method of claim 1,
wherein the RRC command includes data indicating a candidate A-TRS configuration; and
wherein transmitting, by the access node, TRS transmissions to the UE in response to the obtained notification from the UE comprises:
transmitting, by the access node, TRS transmissions to the UE in response to the obtained notification form the UE based on the candidate A-TRS configuration indicated by the RRC command.

75. The method of claim 1, the method further comprising:
obtaining, by the access node, a notification, from the UE, includes data indicating a request for DCI to trigger A-TRS transmissions; and
in response to the obtained request for DCI to trigger A-TRS transmissions, transmitting, by the access node, a DCI command to the UE to trigger A-TRS.

76. The method of claim 3, wherein the DCI command is transmitted via the SCell being activated.

77. The method of claim 3, wherein the DCI command is transmitted via another active cell other than the SCcell being activated.

78. The method of claim 1, the method further comprising:
obtaining, by the access node, a CSI report from the UE.

79. An access node for direct SCell activation comprising:
one or more processors; and
one or more memory devices storing instructions that, when executed by the one or more processors, cause the access node to perform operations, the operations comprising:
generating, by the access node, an RRC command that causes the UE to be configured to initiate UE triggered aperiodic TRS (A-TRS);
encoding, by the access node, the generated RRC command for transmission to the UE;
transmitting, by the access node, the encoded RRC command to the UE;
obtaining, by the access node, data corresponding to a notification, from the UE, that includes data indicating that the UE is ready for A-TRS; and
transmitting, by the access node, TRS transmissions to the UE in response to the obtained notification from the UE.

80. The access node of claim 79,
wherein the RRC command includes data indicating a candidate A-TRS configuration; and
wherein transmitting, by the access node, TRS transmissions to the UE in response to the obtained notification from the UE comprises:
transmitting, by the access node, TRS transmissions to the UE in response to the obtained notification form the UE based on the candidate A-TRS configuration indicated by the RRC command.

81. The access node of claim 79, the operations further comprising:
obtaining, by the access node, a notification, from the UE, includes data indicating a request for DCI to trigger A-TRS transmissions; and
in response to the obtained request for DCI to trigger A-TRS transmissions, transmitting, by the access node, a DCI command to the UE to trigger A-TRS.

82. The access node of claim 79, wherein the DCI command is transmitted via the SCell being activated.

83. The access node of claim 79, wherein the DCI command is transmitted via another active cell other than the SCcell being activated.

84. The access node of claim 79, the operations further comprising:
obtaining, by the access node, a CSI report from the UE.

85. One or more computer readable storage media storing instructions that, when executed by one or more processors, causes the one or more processors of an access node to perform operations, the operations comprising:
generating an RRC command that causes the UE to be configured to initiate UE triggered aperiodic TRS (A-TRS);
encoding the generated RRC command for transmission to the UE;
transmitting the encoded RRC command to the UE;
obtaining data corresponding to a notification, from the UE, that includes data indicating that the UE is ready for A-TRS; and
transmitting TRS transmissions to the UE in response to the obtained notification from the UE.

86. The computer readable media of claim 85,
wherein the RRC command includes data indicating a candidate A-TRS configuration; and
wherein transmitting TRS transmissions to the UE in response to the obtained notification from the UE comprises:
transmitting TRS transmissions to the UE in response to the obtained notification form the UE based on the candidate A-TRS configuration indicated by the RRC command.

87. The computer readable media of claim 85, the operations further comprising:
obtaining a notification, from the UE, includes data indicating a request for DCI to trigger A-TRS transmissions; and
in response to the obtained request for DCI to trigger A-TRS transmissions, transmitting a DCI command to the UE to trigger A-TRS.

88. The computer readable media of claim 85, wherein the DCI command is transmitted via the SCell being activated.

89. The computer readable media of claim 85, wherein the DCI command is transmitted via another active cell other than the SCcell being activated.

90. The computer readable media of claim 85, the operations further comprising:
obtaining a CSI report from the UE.
